(19) United States
(12) Patent Application Publication
(10) Pub. No.: US 2026/0303432 A1
(43) Pub. Date: Oct. 1, 2026

(54) BIT-LEVEL ENERGY-BASED PROBABILISTIC AMPLITUDE SHAPING

(71) Applicant: QUALCOMM Incorporated, San Diego, CA (US)

(72) Inventors: Wei LIU, Beijing (CN); Thomas Joseph RICHARDSON, South Orange, NJ (US); Changlong XU, Beijing (CN); Liangming WU, Beijing (CN); Jian LI, Shanghai (CN); Hao XU, Beijing (CN)

(21) Appl. No.: 19/479,287

(22) PCT Filed: Jun. 23, 2023
(86) PCT No.: PCT/CN2023/102008

§ 371 Date: Oct. 27, 2025

(51) Int. Cl. H04L 27/34; H04L 1/00

(52) U.S. Cl. CPC H04L 27/3405; H04L 1/0042; H04L 1/0058

(57) ABSTRACT

Aspects relate to mechanisms for bit-level energy-based probabilistic amplitude shaping. Energy-based encoding operations may be performed on a plurality of information bits in a parallel or hierarchical manner to produce a plurality of amplitude bits. The plurality of amplitude bits may then be mapped to a plurality of symbols to generate a symbol sequence having a non-uniform distribution over constellation points of an alphabet of symbols forming the symbol sequence.

### TECHNICAL FIELD

The technology discussed below relates generally to wireless communication systems, and more particularly, to constellation shaping in wireless communication systems.

### INTRODUCTION

Wireless communication systems, such as those specified under fourth generation, referred to as Long Term Evolution (LTE) or LTE-Advanced (LTE-A), fifth generation (5G) systems, referred to as New Radio (NR) systems, sixth generation (6G) systems, and other future generations, higher-order modulations (e.g., quadrature amplitude modulation (QAM)-16, QAM-64, and QAM-256) may be used. The constellations in these higher-order modulation systems may be fixed, and each constellation point may be used with an equal probability.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus for wireless communication at a wireless communication device includes one or more memories and one or more processors coupled to the one or more memories. The one or more processors can be configured to obtain a plurality of information bits, perform an energy-based encoding operation on the plurality of information bits to produce a plurality of amplitude bits, and map the plurality of amplitude bits to a plurality of symbols to generate a symbol sequence having a non-uniform distribution over constellation points of an alphabet of symbols forming the symbol sequence.

Another example provides a method operable at a wireless communication device. The method includes obtaining a plurality of information bits, performing an energy-based encoding operation on the plurality of information bits to produce a plurality of amplitude bits, and mapping the plurality of amplitude bits to a plurality of symbols to generate a symbol sequence having a non-uniform distribution over constellation points of an alphabet of symbols forming the symbol sequence.

Another example provides an apparatus configured for wireless communication including means for obtaining a plurality of information bits, means for performing an energy-based encoding operation on the plurality of information bits to produce a plurality of amplitude bits, and means for mapping the plurality of amplitude bits to a plurality of symbols to generate a symbol sequence having a non-uniform distribution over constellation points of an alphabet of symbols forming the symbol sequence.

Another example provides a non-transitory computer-readable medium having stored therein instructions executable by one or more processors of an apparatus for wireless communication to obtain a plurality of information bits, perform an energy-based encoding operation on the plurality of information bits to produce a plurality of amplitude bits, and map the plurality of amplitude bits to a plurality of symbols to generate a symbol sequence having a non-uniform distribution over constellation points of an alphabet of symbols forming the symbol sequence.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system according to some aspects.

FIG. 2 is a diagram providing a high-level illustration of one example of a configuration of a disaggregated base station according to some aspects.

FIG. 3 is a diagram illustrating an example of an energy-based probabilistic amplitude shaping (PAS) architecture according to some aspects.

FIG. 4 is a diagram illustrating an example of bit-level energy shaping circuitry according to some aspects.

FIG. 5 is a diagram illustrating an example of a bits-to-symbol mapping operation according to some aspects.

FIG. 6 is a diagram illustrating an example of a PAS architecture including bit-level energy-based amplitude shaping circuitry according to some aspects.

FIG. 7 is a diagram illustrating another example of bit-level energy shaping circuitry according to some aspects.

FIG. 8 is a diagram illustrating another example of bit-level energy shaping circuitry according to some aspects.

FIG. 9 is a diagram illustrating another example of a bits-to-symbol mapping operation according to some aspects.

FIG. 10 is a diagram illustrating another example of bit-level energy shaping circuitry according to some aspects.

FIG. 11 is a block diagram illustrating an example of a hardware implementation for a wireless communication device employing a processing system according to some aspects.

FIG. 12 is a flow chart illustrating an exemplary process for bit-level energy-based probabilistic amplitude shaping according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

Over an additive white Gaussian noise (AWGN) channel, the channel capacity may be achieved if the input distribution is a Gaussian distribution. When using a higher-order modulation (e.g., QAM-16, QAM-64, or QAM-256), each constellation point may be used with equal probability, which results in a uniform distribution over the constellation. The difference in terms of the signal-to-noise (SNR) to achieve a given target information rate with a given modulation and coding scheme (MCS) between a uniform distribution and an optimal capacity-achieving (e.g., Gaussian) distribution over the constellation may be referred to herein as a shaping gap. For example, for an AWGN channel, the shaping gap may be asymptotically equal to approximately 1.53 dB when the channel inputs are uniformly distributed.

Existing constellation shaping techniques to reduce or close the shaping gap include, for example, geometric shaping and probabilistic shaping. Geometric shaping techniques implement equiprobable signaling with Gaussian-like distributed constellation points. Probabilistic shaping induces a non-uniform (e.g., Gaussian-like) distribution over the constellation points. Traditional approaches to probabilistic shaping include trellis shaping and shell mapping.

Probabilistic amplitude shaping (PAS) is a shaping technique to perform probabilistic shaping. This technique combined an outer layer of shaping with an inner layer of binary forward-error-correction (FEC) coding to provide a low-complexity and flexible integration with existing bit-interleaved coded modulation (BICM) schemes. In some examples, PAS may provide large shaping gain and inherent rate adaptation functionality.

For example, in a symbol-level energy-based PAS architecture, the energy of a sequence of symbols is constrained to be below an energy threshold (e.g., a maximum sequence energy). A target non-uniform distribution over the amplitude symbols can be induced by properly selecting the energy threshold. However, in such symbol-level energy-based shaping schemes, the energy-based quantities are dependent on an alphabet size of an alphabet of symbols forming the constellation points. This results in higher computational complexity, and as such, may increase the latency and increase the fixed read only memory (ROM) storage in wireless communication devices.

Various aspects are related to mechanisms for bit-level energy-based probabilistic amplitude shaping. Energy-based encoding operations may be performed on a plurality of information bits in a parallel or hierarchical manner to produce a plurality of amplitude bits. The energy-based encoding operation may be, for example, an energy-based arithmetic coding operation or an energy-based peeling operation. The plurality of amplitude bits may then be mapped to a plurality of symbols to generate a symbol sequence having a non-uniform distribution over constellation points of an alphabet of symbols forming the symbol sequence. By performing bit-level energy-based PAS, the computational complexity may be reduced, thus reducing the latency and fixed ROM.

In examples in which the energy-based encoding operation is performed in a parallel manner, the plurality of information bits may be segmented into one or more segmented bit sequences, each corresponding to a bit level and having a respective bit-level length. The energy-based encoding operation may then be performed on at least one of the one or more segmented bit sequences in parallel to produce respective shaped bit sequences forming the plurality of amplitude bits. Each of the shaped bit sequences may have a respective non-uniform distribution over a set of binary bit values {0, 1}. In some examples, the respective bit-level length of each of the one or more segmented bit sequences may be determined based on a corresponding bit-level energy threshold. For example, the corresponding bit-level energy threshold for each of the one or more segmented bit sequences may be determined based on a symbol length of the symbol sequence and a shaping parameter, which may be associated with a Maxwell Boltzmann distribution over the alphabet of symbols. Each of the shaped bit sequences may further have a shaped bit length equal to the symbol sequence length and a respective number of bits having a binary value of one at most equal to the corresponding bit-level energy threshold. In some examples, the energy-based encoding operation may be skipped for one or more of the bit levels.

In examples in which the energy-based encoding operation is performed in a hierarchical manner, in a first bit level, a single energy-based encoding operation may be performed on a first set of information bits of the plurality of information bits to produce a first shaped bit sequence. Then, for at least one bit level after the first bit level, a plurality of energy-based encoding operations may be performed. For each of the plurality of energy-based encoding operations of a particular bit level, a respective binary value sequence length from a previous bit level of the plurality of bit levels may be determined. Here, the respective binary value sequence length includes either a first number of bits having a binary value of zero or a second number of bits having a binary value of one from a previous shaped bit sequence of the previous bit level. Then, a respective bit-level length may be determined based on a corresponding respective bit-level energy threshold and the respective binary value sequence length. A set of information bits of the plurality of information corresponding to the respective bit-level length may then be obtained and an energy-based encoding operation may be performed on the set of information bits to produce a shaped bit sequence. In this example, the respective shaped bit sequences from each of the plurality of bit levels including the first bit level form the plurality of amplitude bits. In addition, each of the respective shaped bit sequences has a respective non-uniform distribution over a set of binary bit values {0, 1}. The respective energy-based encoding operations on a same bit level may be performed in parallel and in different bit levels may be performed hierarchically. In addition, the corresponding bit-level energy threshold for each of the energy-based encoding operations based on the output sequence length from the previous bit level and a shaping parameter, which may be associated with a Maxwell Boltzmann distribution over the alphabet of symbols. In some examples, the energy-based encoding operation may be skipped for one or more of the bit levels.

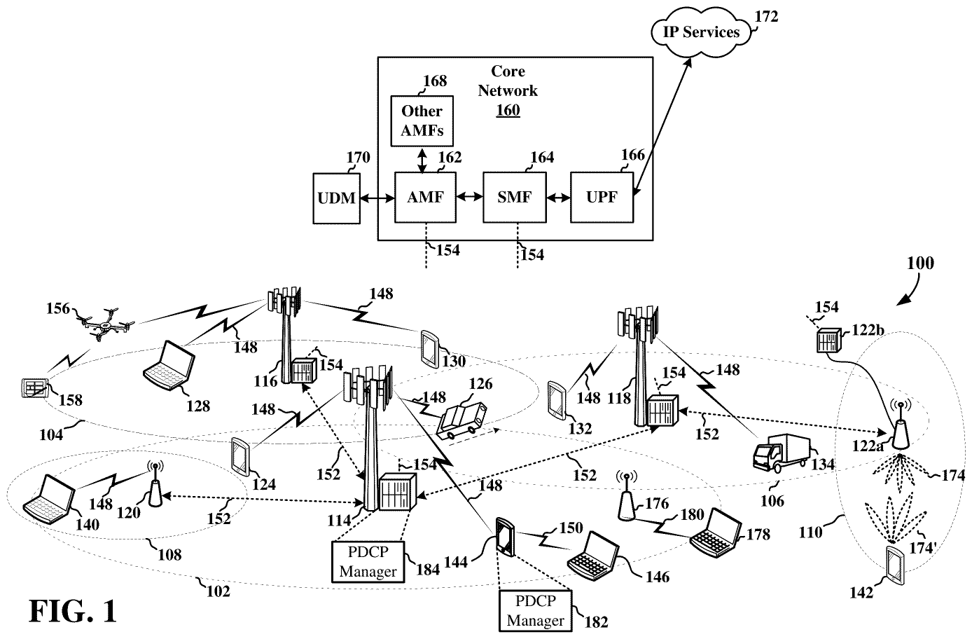

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

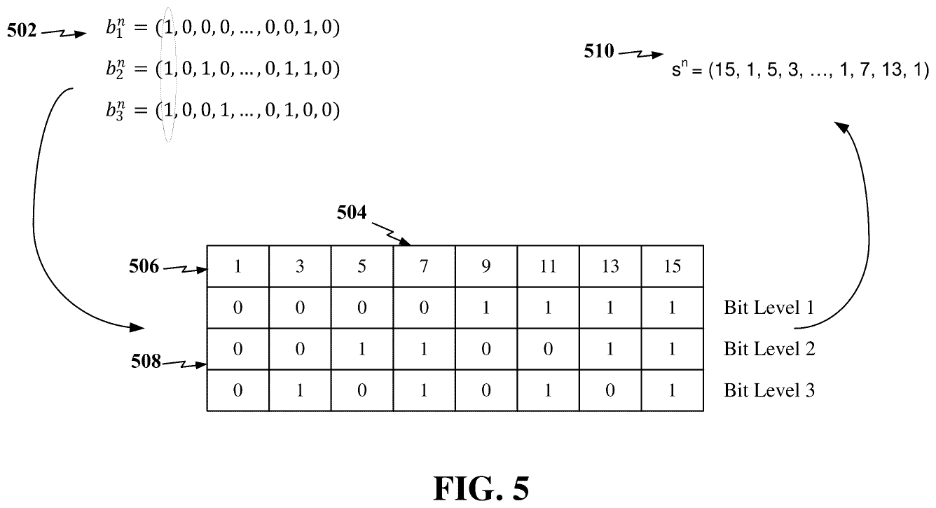

NR 5G wireless communication systems (and other future generations) may support one or more frequency ranges, including FR1, FR2 or a legacy LTE frequency range. For example, the LTE frequency range may include the E-UTRA frequency bands between 350 MHz and 3.8 GHz. In some examples, each cell may support a single frequency range (e.g., FR1, FR2 or legacy LTE) and may further support one or more frequency bands (e.g., carrier frequencies) within a particular frequency range. In addition, one or more cells may operate as anchor cells enabling dual connectivity with neighbor cell(s) supporting a different frequency range. In some examples, one or more cells may be NR dual connectivity (NR DC) cells that support dual connectivity between FR1 and FR2 (e.g., FR1+FR2 DC). For example, a NR DC anchor cell may be configured for communication with UEs in the cell over FR1, and may further support dual connectivity by the UEs to enable simultaneous communication over FR1 with the NR DC anchor cell and over FR2 with one or more neighbor NR cells. In other examples, one or more cells may be Evolved-Universal Terrestrial Radio Access New Radio dual connectivity (EN-DC) that support dual connectivity between an LTE frequency band and either FR1 or FR2, as described in more detail below in connection with FIG. 5. For example, an LTE anchor cell may be configured for communication with UEs in the cell over an LTE frequency band, and may further support dual connectivity by the UEs to enable simultaneous communication over the LTE frequency band with the LTE anchor cell and over either FR1 or FR2 with one or more neighbor NR cells.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

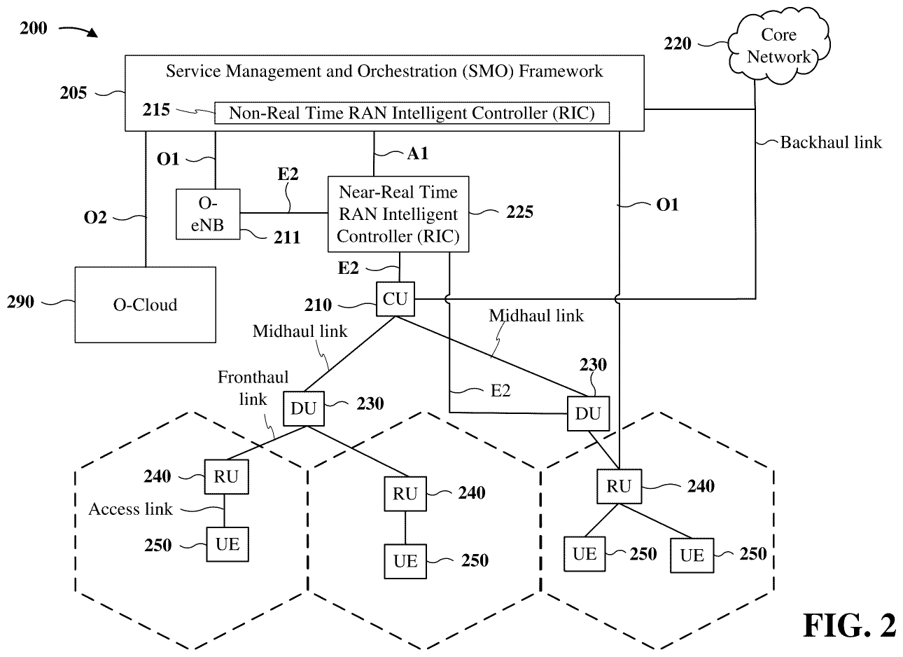

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

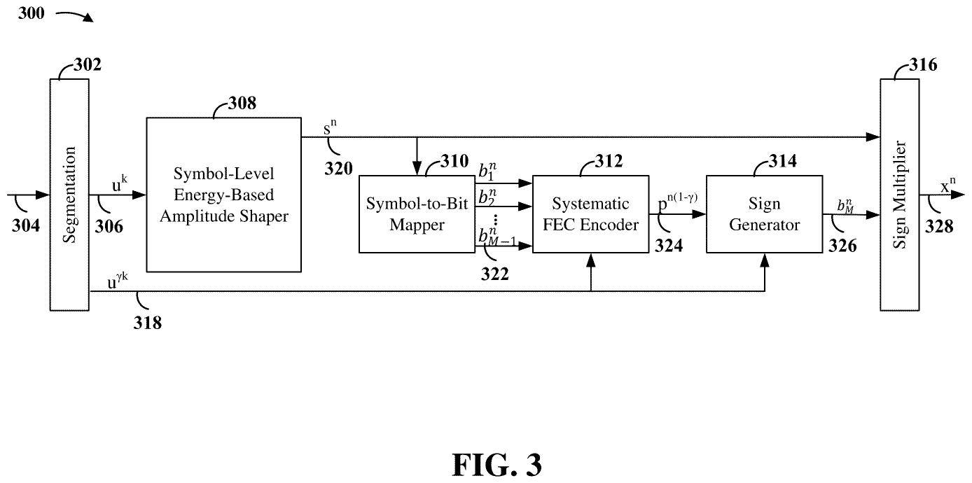

FIG. 3 is a diagram illustrating an example of an energy-based probabilistic amplitude shaping (PAS) architecture according to some aspects. The architecture 300 shown in FIG. 3 may be included in a transmitter chain of a wireless communication device (e.g., a UE or network entity, as shown in FIGS. 1 and/or 2). The transmitter chain may be configured for amplitude shift keying (ASK) constellations with modulation order 2^{M}. For example, an ASK constellation may include constellation points {±1, ±3, . . . , ±(2^{M}−1)} with amplitude alphabet {1, 3, . . . , 2^{M}−1}. The transmitter chain may further be generalized to QAM constellations with modulation order 2^{2M} For example, a QAM constellation may include constellation points in {±1, ±3, . . . , ±(2^{M}−1)}×{±1, ±3, . . . , +(2^{M}−1)} with amplitude alphabet {1, 3, . . . , 2^{M}−1}.

The architecture 300 includes a segmentation block 302, a symbol-level energy-based amplitude shaper 308, a symbol-to-bit mapper 310, a systematic forward-error-correction (FEC) encoder 312, a sign generator 314, and a sign multiplier 316. An input bit sequence 304 may be segmented by the segmentation block 302 into a plurality of information bits u^{k} (e.g., u^{k}=(u₁, u₂, . . . , uₖ)) and extra information bits u^{γn}. The symbol-level energy-based amplitude shaper 308 with rate Rₐₛ=k/n encodes the k information bits to produce a sequence of n symbols (sⁿ) 320.

Here, the sequence sⁿ=(s₁, s₂, . . . , sₙ) includes the n symbols, with each symbol belonging to an alphabet [symbol] . For example, let [symbol] ={a₁, a₂, . . . , aₘ} be an alphabet having an alphabet size m>1 with each element of alphabet [symbol] being a symbol. For example, for a 2^{M}-ary ASK constellation, let [symbol] ={1, 3, . . . , 2^{M}−1}, so that m=2^{M}−1 (e.g., m is a power of 2 and depends on the modulation order). In addition, let aᵢ=2i−1, so that a₁=1, a₂=3, . . . , aₘ=2^{M}−1 and {−1, 1}× [symbol] corresponds to the 2^{M} ary ASK constellation.

Given the alphabet [symbol] ={a₁, a₂, . . . , aₘ} of alphabet size m, the energy of each symbol aᵢ may be denoted E(aᵢ). It can be assumed that the symbol energies are distinct, and for any i∈{1, 2, . . . , m−1}, the symbol energy may be 0≤E(aᵢ)<E(aᵢ₊₁). In a first example, for each i, the energy E(aᵢ) of symbol aᵢ may be E(aᵢ)=(2i−1)². In a second example, for each i, the energy E(aᵢ) of symbol aᵢ may be E(aᵢ)=i(i−1)/2. Here, since 8E(aᵢ)+1=(2i−1)², E(aᵢ) may involve a shifted scaling of (2i−1)² in the first example.

For the alphabet [symbol] of alphabet size m, with a symbol sequence s=(s₁, s₂, . . . , sₙ) of a sequence length n over [symbol] , the energy of the sequence s, denoted E(s), is defined as a sum of all of the symbol energies as follows:

$$E ( s ) = {\sum }_{l = 1}^{n} E ( {s}_{l} )$$

The symbol-level energy-based amplitude shaper 308 may be configured to constrain the energy of sⁿ 320 to be below an energy threshold (e.g., a maximum sequence energy), which may be referred to as Ē. By properly selecting Ē, a targeted non-uniform distribution over the amplitude symbols may be induced to reduce or close the shaping gap. The non-uniform symbol-wise marginal distribution over the n amplitude symbols induced by the energy-based amplitude shaper 308 may be closer to the capacity-achieving input distribution than the uniform distribution (e.g., the non-uniform distribution may be a Maxwell-Boltzmann (MB) distribution for the AWGN channel.

Thus, the symbol-level energy-based amplitude shaper 308 may be configured to directly encode a plurality of k information bits to a symbol sequence sⁿ 320. This symbol sequence 320 may be within a set of all sequences [symbol] (m, n, E) [symbol] {s|sᵢ∈ [symbol] , i∈{1, 2, . . . , n}E(s)≤E}, where each respective sequence has a length equal to the sequence length of n, each element of each respective sequence belongs to the alphabet [symbol] , and each respective sequence has an energy at most equal to the maximum sequence energy Ē. The symbol-level energy-based amplitude shaper 308 may induce an injective mapping from the set of all 2^{k} bit sequences to [symbol] (m, n, Ē). In this example, the cardinality of the set of sequences [symbol] (m, n, Ē) (e.g., the total number of distinct sequences in the set [symbol] (m, n, Ē)) may be represented as:

$${N}_{c}^{[ m ]} ( n , E ) = \vert 𝒮 ( m , n , E ) \vert$$

When the alphabet size m is clear, the superscript [m] may be omitted and the cardinality may be represented as N_{c}(n,E) as a proxy. For a given m, N_{c}(n,E) is a two-variable integer-valued function of n and E. For example, if m=2 and [symbol] ={a₁, a₂}, then E(a₁)=0 and E(a₂)=1.

The symbol sequence sⁿ 320 may be converted by the symbol-to-bit mapper 310 to (M−1) bit sequences 322 of length n denoted as

$${b}_{1}^{n} , {b}_{2}^{n} , … , {b}_{M - 1}^{n}$$

(e.g., each of the n amplitude symbols corresponds to (M−1) bits, which respectively contribute 1-bit to the bit sequences). These in total give rise to n(M−1) amplitude bits. The n(M−1) amplitude bits 322 and the γn extra information bits (u^{γn}) 318 collectively constitute n(M−1+γ) bits. The n(M−1+γ) bits 318 and 322 are input to the systematic FEC encoder 312 with rate R_{c}=(M−1+γ)/M. The systematic FEC encoder 312 generates n(1−γ) parity bits (p^{n(1-γ)}) 324. These n(1−γ) parity bits 324, together with the γn extra information bits (u^{γn}) 318, are input to the sign generator 314, where they are converted to n sign bits

$$( {b}_{M}^{n} )$$

326. The n sign bits 326 are pointwise multiplied with the n amplitude symbols 320 in sⁿ by the sign multiplier 316 to produce an output symbol sequence xⁿ 328. The resulting transmission rate may be represented as Rₜ=Rₐₛ+γ.

For higher-order modulations, one or more values of the alphabet size m are needed, which is generally greater than one (e.g., for QAM-64, m=4, and for QAM-256, m=8). The symbol-level energy-based scheme shown in FIG. 3 involves determining energy-based quantities, N(n,E) and N_{c}(n,E), exactly or approximately for a wide range of n and E. Such energy-based quantities are m-dependent, and as a result, the symbol-level energy-based shaping scheme shown in FIG. 3 is m-dependent. This may result in larger computational complexity and/or a larger fixed-ROM storage for symbol-level energy-based shaping. Therefore, various aspects of the disclosure are directed to bit-level energy-based schemes that may reduce computational complexity and latency of energy-based shaping and reduce the fixed-ROM storage requirements of energy-based shaping.

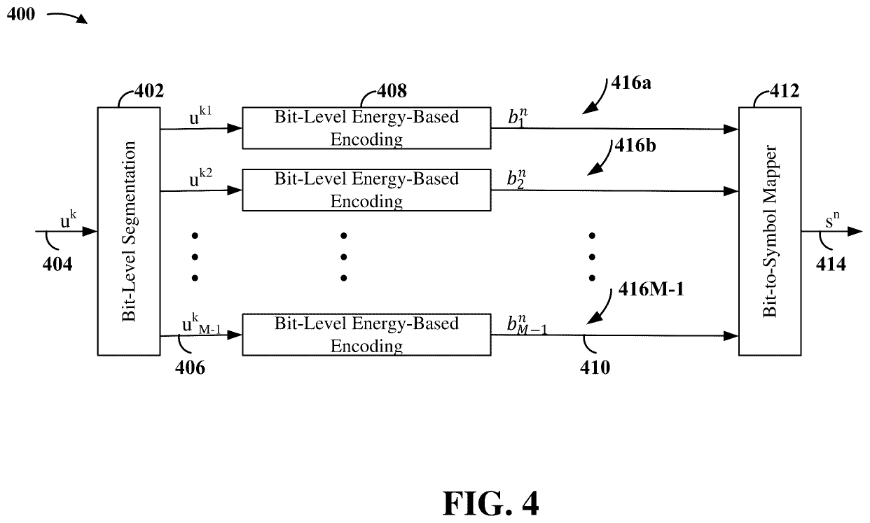

FIG. 4 is a diagram illustrating an example of bit-level energy shaping circuitry according to some aspects. The circuitry 400 may be included, for example, in a PAS architecture of a transmitter chain of a wireless communication device (e.g., UE or network entity). The circuitry includes a bit-level segmentation block 402, bit-level energy-based encoding blocks 408, and a bit-to-symbol mapper 412. The bit-level segmentation block 402 is configured to segment a plurality of information bits (u^{k}) 404 into one or more segmented bit sequences 406 (e.g., u^{k}^{₁}, u^{k}^{₂}, . . . , u^{k}^{_{M-1}}). Each of the segmented bit sequences 406 corresponds to a bit level 416a, 416b, . . . 416M−1 and each segmented bit sequence 406 has a respective bit-level length.

The respective bit-level length of each of the one or more segmented bit sequences 406 may be determined based on a corresponding bit-level energy threshold. From the identified bit-level lengths of each of the one or more segmented bit sequences, a bit sequence length of the plurality of information bits 404 may be ascertained. Thus, the bit-level segmentation block 402 may first determine the respective bit-level length for each of the bit levels 416a, 416b, . . . 416M−1 and then obtain a plurality of information bits 404 equal to a sum of all of the bit-level lengths. The bit-level segmentation block 402 may then segment the plurality of information bits 404 into the one or more segmented bit sequences 406 in accordance with the respective bit-level lengths of each of the bit-levels 416a, 416b, . . . 416M−1.

As described above, considering an alphabet of symbols [symbol] ={a₁, a₂, . . . , aₘ} having an alphabet size m, the alphabet [symbol] depends on the modulation order and the alphabet size m is 2 to the power of a positive integer (e.g., m is a power of 2 and m>1). For example, alphabet size m is one-half of 2^{M} for an ASK constellation of order 2^{M} and one-half of a square of 2^{2M} for a QAM constellation of order 2^{2M}. A sequence of symbols (e.g., produced by the bit-to-symbol mapper 412) of the alphabet [symbol] may have a symbol sequence length of n.

The number of bit levels may be determined based on the alphabet size m. For example, the number of bit levels may be at most equal to a logarithm of the alphabet size m under base 2 (e.g., log₂ m=M−1). For each of the bit levels, the corresponding bit-level energy threshold (e.g., maximum sequence energy) may be determined based at least in part on a symbol sequence length of n and a shaping parameter v. The shaping parameter v may be, for example, associated with a Maxwell-Boltzmann distribution over the alphabet [symbol] .

For example, for i={1, 2, . . . , m}, where i corresponds to a bit level, Ēᵢ=Ēᵢ(n, v). Thus, each Ēᵢ corresponds to a respective bit level and is the bit-level energy threshold (e.g., maximum sequence energy) for that bit level. In addition, each Ēᵢ is based on a product of the symbol sequence length n and a respective normalized maximum sequence energy ω̅ᵢ. Each respective normalized maximum sequence energy ω̅ᵢ is based on the shaping parameter v. For example, ω̅ᵢ=ω̅ᵢ(v), and then Ēᵢ(n, v)=nω̅ᵢ(v). The correspondence in value between the shaping parameter v and each respective ω̅ᵢ for each bit level may be, for example, tabulated in one more look-up tables or computationally determined in real-time.

From the bit-level energy thresholds, the respective bit-level lengths of each of the one or more segmented bit sequences 406 may be determined. For example, each bit-level sequence length kᵢ may be based on the symbol sequence length n and the respective bit-level energy threshold Ēᵢ. In an example, for each i, the bit-level sequence length kᵢ is a positive integer satisfying the equation:

$${k}_{i} \leq l o {g}_{2} {N}_{c}^{[ 2 ]} ( n , {\overline{E}}_{i} )$$

Thus, kᵢ is at most equal to a logarithm of a total quantity of sequences of bits, where each sequence of bits of the sequences of bits is of a respective length equal to n and has a respective number of bits having a binary value of one at most equal to Ēᵢ. The bit sequence length k (of u^{k} 404) is equal in value to a sum of the bit-level sequence lengths kᵢ. Thus, k=k₁+k₂, . . . , k_{M-1}.

Each of the one or more segmented bit sequences 406 (u^{k}^{₁}, u^{k}^{₂}, . . . , u^{k}_{M-1}) may be input to a respective bit-level energy-based encoding block 408 to perform a respective bit-level energy-based encoding operation on each of the one or more segmented bit sequences 406 to produce respective shaped bit sequences 410

$$( e . g . , {b}_{1}^{n} , {b}_{2}^{n} , … , {b}_{M - 1}^{n} ) .$$

The bit-level energy-based encoding operations may be performed in parallel by each of the bit-level energy-based encoding blocks 408. Each of the respective shaped bit sequences 410 may correspond to a respective non-uniform marginal distribution over the set of binary bit values {0, 1}. For example, for the shaped bit sequence

$${b}_{1}^{n}$$

corresponding to the first bit level 416a, there may be a target distribution p_1 over {0, 1}, such that p_1(0)=0.3 and p_1(1)=0.7. Similarly, for the second bit level 416b, there can be a different target distribution p_2 over {0, 1}, such that p_2(0)=0.4 and p_2(1)=0.6.

In some examples, each shaped bit sequence 410 may have a length equal to the sequence length n. In addition, each shaped bit sequence 410 may have a total number of bits having a binary value of one at most equal to the respective bit-level energy threshold Ēᵢ. For example,

$${u}_{1}^{k}$$

is shaped into

$${b}_{1}^{n} ,$$

which is a shaped bit sequence of length n and has a total number of binary value ones at most equal to Ē₁.

In some examples, each of the bit-level energy-based encoding blocks 408 may be based on a respective energy-based shaping scheme for the m=2 case. For example, the energy-based encoding operation performed by one or more of the bit-level energy-based encoding blocks 408 may include an energy-based arithmetic coding operation. As another example, the energy-based encoding operation performed by one or more of the bit-level energy-based encoding blocks 408 may include an energy-based peeling operation.

The respective individual shaped bit sequences 410 collectively form a plurality of amplitude bits. The plurality of amplitude bits are input to the bit-to-symbol mapper 412, which performs a bit-to-symbol mapping operation on the plurality of amplitude bits, thereby generating a symbol sequence 414 (sⁿ). The empirical marginal distribution over {0, 1} for each the shaped bits sequences 410 is close to (e.g., substantially equal to) the respective target distributions for each of the bit levels 416a, 416b, . . . , 416M−1, such that when the plurality of amplitude bits are converted to amplitude symbols 414 by the bit-to-symbol mapper 412, the empirical distribution over the amplitude symbols 414 (e.g., the symbol sequence sⁿ) is close to (e.g., substantially equal to) a target non-uniform distribution over constellation points of the alphabet of symbols used to generate the symbol sequence 414 (e.g., symbols {1, 3, 5, 7} for an example of 8ASK). For example, the target non-uniform distribution (which may be referred to as q) over the amplitude symbols of 8ASK may be q(1)=0.5, q(3)=0.25, q(5)=0.15, and q(7)=0.1.

The symbol sequence 414 may have a symbol sequence length of n. The bit-to-symbol mapper 412 may perform the mapping based at least in part on the shaped bit sequences 410 and a bits-to-symbol labeling strategy. For example, the bits-to-symbol labeling strategy may include natural labeling, Gray labeling, or one-to-one labeling. In an example, the bits-to-symbol mapper 412 may perform a total number of n bits-to-symbol conversions. Each bits-to-symbol conversion may take as input M−1 bits, each one of which is from a respective shaped bit sequence 410 and map the M−1 bits to a symbol of the alphabet [symbol] , thereby generating an element of sⁿ 414.

FIG. 5 is a diagram illustrating an example of a bits-to-symbol mapping operation according to some aspects. In the example shown in FIG. 5, a natural bits-to-symbol labeling strategy is used (e.g., for ASK-16 or QAM-256). In addition, three shaped bit sequences 502

$$( e . g . , {b}_{1}^{n} , {b}_{2}^{n} , {b}_{3}^{n} )$$

are provided for illustration. However, depending on the alphabet size, more or fewer shaped bit sequences may be generated. Here,

$${b}_{1}^{n} = ( 1 , 0 , 0 , 0 , … , 0 , 0 , 1 , 0 ) , {b}_{2}^{n} = ( 1 , 0 , 1 , 0 , … , 0 , 1 , 1 , 0 ) , and$$

$${b}_{3}^{n} = ( 1 , 0 , 0 , 1 , \text{…} , 0 , 1 , 0 , 0 ) .$$

In the natural labeling strategy, the corresponding position bits in each of the shaped bit sequences 502 are used as input to a table 504 containing symbols 506 and corresponding bit values 508 to generate the corresponding position symbol in an output symbol sequence 510 (sⁿ). For example, taking the first bit in each of the bit sequences 502 (e.g., 1, 1, 1) as input to the table 504 produces a first output symbol of 15. Similarly, taking the second bit in each of the shaped bit sequences 502 as input to the table 504 produces a second output symbol of 1. By inputting the corresponding bits in each of the shaped bit sequences 502 shown in FIG. 5 to the table 504, the resulting output symbol sequence 510 may be sⁿ=(15, 1, 5, 3, . . . , 1, 7, 13, 1).

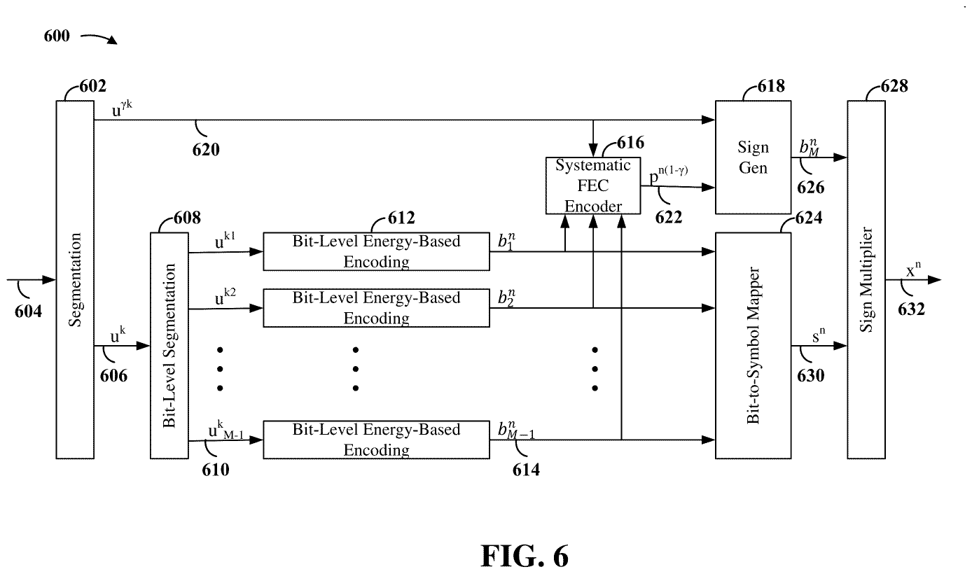

FIG. 6 is a diagram illustrating an example of a PAS architecture including bit-level energy-based amplitude shaping circuitry according to some aspects. The architecture 600 shown in FIG. 6 may be included in a transmitter chain of a wireless communication device (e.g., a UE or network entity, as shown in FIGS. 1 and/or 2). The architecture 600 includes a segmentation block 602, a bit-level segmentation block 608, bit-level energy-based encoding blocks 612, a systematic forward-error-correction (FEC) encoder 616, a sign generator 618, a bit-to-symbol mapper 624, and a sign multiplier 628. An input bit sequence 604 may be segmented by the segmentation block 602 into a plurality of information bits u^{k} 606 and extra information bits u^{γn} 620. The plurality of information bits 606 are input to the bit-level segmentation block 608 to produce the one or more segmented bit sequences 610 (e.g., u^{k}^{₁}, u^{k}^{₂}, . . . , u^{k}^{_{M-1}}), each of which has a bit-level sequence length kᵢ, as described above in connection with FIG. 4.

The bit sequence length k of the plurality of information bits u^{k} may be determined by the bit-level segmentation block 608 based on the respective bit-level sequence lengths kᵢ, which may be determined, for example, based on the corresponding bit-level energy thresholds Ēᵢ and the symbol sequence length n, as described above in connection with FIG. 4. Thus, the extra information bits 620 may be non-selected ones of the input bit sequence 604 (information bits not part of the k information bits).

The segmented bit sequences 610 are each input to a corresponding bit-level energy-based encoding block 612 to produce respective shaped bit sequences 614

$$( e . g . , {b}_{1}^{n} , {b}_{2}^{n} , … , {b}_{M - 1}^{n} ) ,$$

as described above in connection with FIG. 4. The shaped bit sequences 614 are input to the bit-to-symbol mapper 624 to generate a symbol sequence sⁿ 630, as described above in connection with FIG. 4.

The shaped bit sequences 614 in total account for n(M−1) amplitude bits. The n(M−1) amplitude bits together with the extra γn extra information bits (u^{γn}) 620 collectively constitute n(M−1+γ) bits. The n(M−1+γ) bits 614 and 620 are input to the systematic FEC encoder 616 with rate R_{c}=(M−1+γ)/M. The systematic FEC encoder 616 generates n(1−γ) parity bits (p^{n(1-γ)}) 622. These n(1−γ) parity bits 622, together with the γn extra information bits (u^{γn}) 620, are input to the sign generator 618, where they are converted to a sequence of n sign bits

$$( {b}_{M}^{n} )$$

626. The n sign bits 626 are pointwise multiplied with the n amplitude symbols 630 in the symbol sequence sⁿ by the sign multiplier 628 to produce an output (transmission) symbol sequence xⁿ 632 for transmission by the wireless communication device.

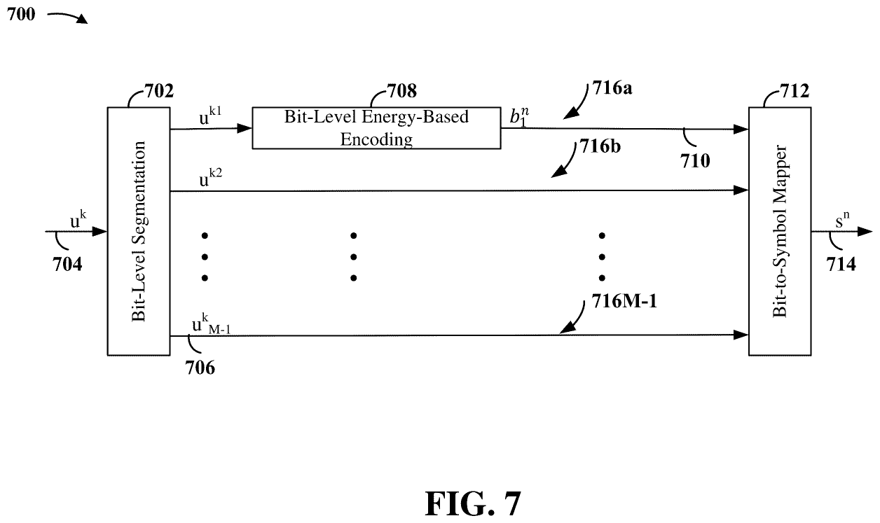

FIG. 7 is a diagram illustrating another example of bit-level energy shaping circuitry according to some aspects. The circuitry 700 may be included, for example, in a PAS architecture of a transmitter chain of a wireless communication device (e.g., UE or network entity). The circuitry 700 includes a bit-level segmentation block 702, bit-level energy-based encoding block(s) 708, and a bit-to-symbol mapper 712. The bit-level segmentation block 702 is configured to segment a plurality of information bits (u^{k}) 704 into one or more segmented bit sequences 706 (e.g., u^{k}^{₁}, u^{k}^{₂}, . . . , u^{k}^{_{M-1}}). Each segmented bit sequence 706 is associated with a bit level 716a, 716b, . . . , 716M−1 has a respective bit-level length.

From the bit-level lengths of each of the one or more segmented bit sequences, a bit sequence length of the plurality of information bits 704 may be ascertained. Thus, the bit-level segmentation block 702 may first determine the respective bit-level length for each of the bit levels 716a, 716b, . . . , 716M−1 and then obtain a plurality of information bits 704 equal to a sum of all of the bit-level lengths. The bit-level segmentation block 702 may then segment the plurality of information bits 704 into the one or more segmented bit sequences 706 in accordance with the respective bit-level lengths of each of the bit-levels 716a, 716b, . . . , 716M−1.

In some examples, an energy-based encoding operation may be performed for less than all of the bit levels 716a, 716b, . . . 716M−1. Thus, an energy-based encoding operation may be skipped for one or more of the bit levels. Here, the one or more skipped bitt levels may be less than logarithm of the alphabet size m under base 2. For each skipped bit level, the corresponding bit-level sequence length is equal to the sequence length n (e.g., kᵢ=n for all i∈{2, . . . , m}). For each non-skipped bit level, the corresponding bit-level sequence length may be determined based on a corresponding bit-level energy threshold and a symbol sequence length n. The skipped bit levels may be regarded as a special form of shaped distribution corresponding to uniform distribution.

In the example shown in FIG. 7, a most-significant bit (MSB) bit level 716a is energy encoded and the remaining (least-significant bit (LSB)) bit levels 716b . . . 716M−1 are skipped. For example, the segmented bit sequence u^{k}^{₁} may be input to the bit-level energy-based encoding block 708 to perform a bit-level energy-based encoding operation on the segmented bit sequence to produce a shaped bit sequence 710. The shaped bit sequence 710 and skipped segmented bit sequences 706 (e.g., u^{k}^{₂}, . . . , u^{k}^{_{M-1}}) may collectively form the plurality of amplitude bits that are then input to the bit-to-symbol mapper 712, which performs a bit-to-symbol mapping operation using a bit-to-symbol labeling strategy to generate a symbol sequence 714 (sⁿ). The symbol sequence 714 may have a symbol sequence length of n. In an example, the bits-to-symbol mapper 712 may perform a total number of n bits-to-symbol conversions. Each bits-to-symbol conversion may take as input M−1 bits, each one of which is from a respective shaped bit sequence 710 or skipped segmented bit sequence 706 and map the M−1 bits to a symbol of the alphabet [symbol] , thereby generating an element of sⁿ 714.

For a given bits-to-symbol mapping (e.g., via natural labeling, Gray labeling, one-to-one labeling, etc.), a symbol a∈ [symbol] , and amplitude bits b₁, b₂, . . . , b_{M-1} corresponding to a according to the bits-to-symbol mapping, a target probability can be written as:

$$p ( a ) = {\prod }_{t = 1}^{M - 1} p ( {b}_{t} \vert {b}_{t - 1} , … , {b}_{1} )$$

That is, the symbol-level target distribution induces a plurality of bit-level target conditional distributions, and the symbol-level target distribution can be written as a product of the bit-level target conditional distributions. Therefore, approaching the symbol-level target distribution may be realized by approaching each one of the bit-level target distributions.

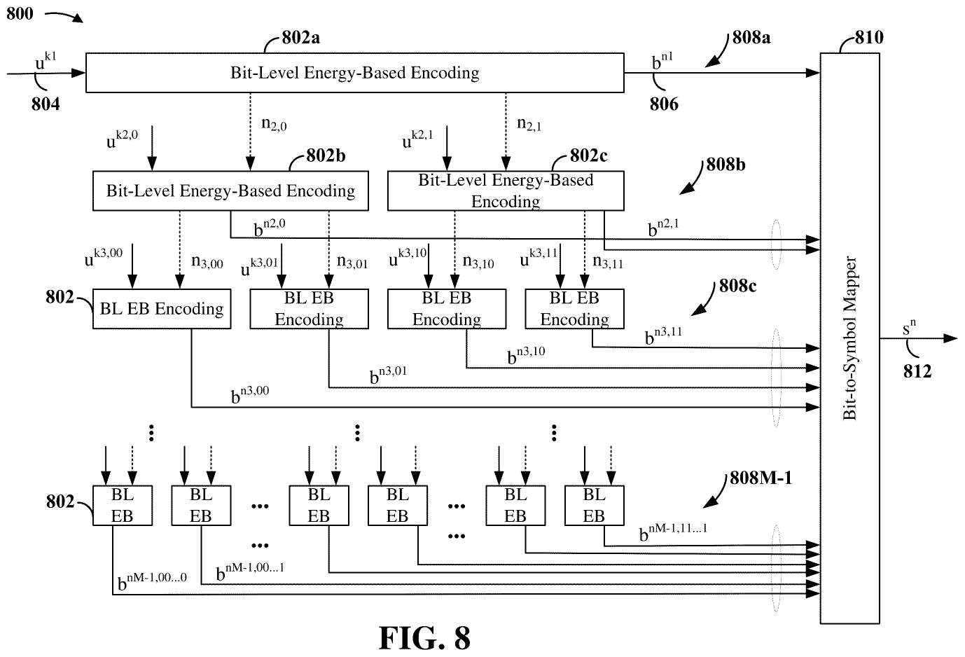

FIG. 8 is a diagram illustrating another example of bit-level energy shaping circuitry according to some aspects. The circuitry 800 may be included, for example, in a PAS architecture of a transmitter chain of a wireless communication device (e.g., UE or network entity). The circuitry 800 shown in FIG. 8 may enable bit-level target distributions to be achieved, thus facilitating realization of a symbol-level target distribution.

As described above, considering an alphabet of symbols [symbol] ={a₁, a₂, . . . , aₘ} having an alphabet size m, the alphabet [symbol] depends on the modulation order and the alphabet size m is 2 to the power of a positive integer (e.g., m is a power of 2 and m>1). For example, alphabet size m is one-half of 2^{M} for an ASK constellation of order 2^{M} and one-half of a square of 2^{2M} for a QAM constellation of order 2^{2M}. A sequence of symbols of the alphabet [symbol] may have a symbol sequence length of n.

The circuitry 800 includes a plurality of bit-level energy-based encoding blocks 802 (including 802a, 802b, and 802c) and a bit-to-symbol mapper 810. The bit-level energy-based encoding blocks 802 are arranged to perform energy-based encoding operations hierarchically across different bit levels 808a, 808b, 808c, . . . 808M−1 and to perform energy-based encoding operations in parallel for a same bit level. In general, bit-level energy shaping may be performed in a hierarchical manner with each iteration of bit-level energy shaping (e.g., corresponding to a bit level 808a, 808b, 808c, . . . 808M−1) being represented by a variable t (e.g., t=1, t=2, t=3, . . . , t=M−1, when M>2). For example, bit-level energy-based shaping step t corresponds to bit level t and a total number of energy-based encoding operations for step tis equal to 2^{t-1}.

For example, in a first iteration (e.g., by initializing t=1 and n₁=n) for a first bit level 808a, a maximum sequence energy (energy threshold) Ē₁ for the first bit level may be determined (e.g., by a bit segmentation block, not shown) The energy threshold may be determined based at least in part on the sequence length n, the alphabet [symbol] , and the shaping parameter v, as described above. The shaping parameter v may be, for example, associated with a Maxwell-Boltzmann distribution over the alphabet [symbol] .

Based on the energy threshold Ē₁ and the sequence length n, a bit-level length for the first bit level 808a may be determined. For example, the first bit-level length k₁ may be determined such that

$${k}_{1} \leq {log}_{2} {N}_{c}^{[ 2 ]} ( n , {\overline{E}}_{1} ) .$$

A number k₁ of information bits may then be obtained (e.g., by a bit segmentation block, such as the bit segmentation block shown in FIG. 4) to form a first set of information bits u^{k}^{₁} 804. The bit-level energy-based encoding block 802a for the first bit level 808a may perform an energy-based encoding operation on the first set of information bits 804 to produce a first shaped bit sequence bⁿ^{₁} 806. For example, the bit-level energy-based encoding block 802a may use an energy-based shaping scheme, such as energy-based arithmetic coding or energy-based peeling to produce the first shaped bit sequence 806. In the case of m=2, [symbol] ={a₁, a₂} and E(a₁)=0 and E(a₂)=1.

The bit-level energy-based encoding block 802a for the first bit level 808a may then determine a first number of bits having a binary value of zero in bⁿ^{₁} and denote that n_{2,0}. In addition, the bit-level energy-based encoding block 802a for the first bit level 808a may further determine a second number bits having a binary value of one in bⁿ^{₁} and denote that n_{2,1}. Here, n_{2,1}=n−n_{2,0}. Then, t may be incremented by one.

In a second iteration (t=2) for the second bit level 808b, two bit-level energy-based encoding operations are performed in parallel, each by a respective bit-level energy-based encoding block 802b and 802c. For example, as described above, the total number of energy-based encoding operations for step t is equal to 2^{t-1}, and as such, there are two energy-based encoding operations for the second bit level 808b.

Bit-level energy-based encoding block 802b may receive as input from the bit-level energy-based encoding block 802a of the first bit level 808a, the first number of bits n_{2,0}. Energy-based encoding block 802b may then determine an energy threshold (Ē_{2,0}) based at least in part on the sequence length n_{2,0}, the alphabet [symbol] , and the shaping parameter v. Based on the energy threshold Ē_{2,0} and the sequence length n_{2,0}, a first bit-level length for the second bit level 808b may be determined. For example, the first bit-level length k_{2,0} may be determined such that

$${k}_{2 , 0} \leq {log}_{2} {N}_{c}^{[ 2 ]} ( {n}_{2 , 0} , {\overline{E}}_{2 , 0} ) .$$

A number k_{2,0} of information bits may then be obtained (e.g., by a bit segmentation block, such as the bit segmentation block shown in FIG. 4) to form a second set of information bits u^{k}^{_{2,0}}. The bit-level energy-based encoding block 802b may perform an energy-based encoding operation on the second set of information bits u^{k}^{_{2,0}} to produce a second shaped bit sequence bⁿ^{_{2,0}}.

In addition, bit-level energy-based encoding block 802c may receive as input from the bit-level energy-based encoding block 802a of the first bit level 808a, the second number of bits n_{2,1}. Energy-based encoding block 802c may then determine an energy threshold (Ē_{2,1}) based at least in part on the sequence length n_{2,1}, the alphabet [symbol] , and the shaping parameter v. Based on the energy threshold Ē_{2,1} and the sequence length n_{2,1}, a second bit-level length for the second bit level 808b may be determined. For example, the second bit-level length k_{2,1} may be determined such that

$${k}_{2 , 1} \leq {log}_{2} {N}_{c}^{[ 2 ]} ( {n}_{2 , 1} , {\overline{E}}_{2 , 1} ) .$$

A number k_{2,1} of information bits may then be obtained (e.g., by a bit segmentation block, such as the bit segmentation block shown in FIG. 4) to form a third set of information bits u^{k}^{_{2,1}}. The bit-level energy-based encoding block 802c may perform an energy-based encoding operation on the second set of information bits u^{k}^{_{2,1}} to produce a second shaped bit sequence bⁿ^{_{2,1}}.

Each bit-level energy-based encoding block 802b and 802c in the second bit level 808a may then determine a respective number of bits having a binary value of zero (e.g., in bⁿ^{_{2,0}} and bⁿ^{_{2,1}}) and denote those respectively as n_{3,00} and n_{3,10}. In addition, the bit-level energy-based encoding blocks 802b and 802c for the second bit level 808b may further determine a respective second number bits having a binary value of one (e.g., in bⁿ^{_{2,0}} and bⁿ^{_{2,1}}) and denote those respectively as n_{3,10} and n_{3,11}. Then, t may be incremented by one. In a third iteration (t=2) for the third bit level 808c, six bit-level energy-based encoding operations are performed in parallel, each by a respective bit-level energy-based encoding block 802. For example, as described above, the total number of energy-based encoding operations for step t is equal to 2^{t-1}, and as such, there are six energy-based encoding operations for the third bit level 808c.

In general, for each bit level 808a, 808b, . . . 808M−1, each energy-based encoding operation performed by a corresponding energy-based encoding block is associated with a respective index of the form {t, (b₁, b₂, . . . , bₜ₋₁)}, with each bᵢ∈{0,1}. Each energy-based encoding operation receives a respective binary value sequence length n_{t, b1, b2, . . . , b}_{ₜ₋₁} from a previous step (e.g., an energy-based encoding operation/block of an immediately prior bit level). Each binary value sequence length indicates a number of binary values 0s or binary value 1s produced by the immediately prior energy-based encoding operation. Each energy-based encoding operation determines a respective maximum sequence energy (energy threshold) Ē_{t, b1, b2, . . . , b}_{ₜ₋₁} based on the respective binary value sequence length.

For example, the energy threshold Ē_{t, b1, b2, . . . , b}_{ₜ₋₁} may be determined based at least in part on n_{t, b1, b2, . . . , b}_{ₜ₋₁}, the alphabet [symbol] , and the shaping parameter v. Each Ē_{t, b1, b2, . . . , b}_{ₜ₋₁} is based on a product of the sequence length n_{t, b1, b2, . . . , b}_{ₜ₋₁} and a respective normalized maximum sequence energy ω̅_{t, b1, b2, . . . , b}_{ₜ₋₁}. Each respective normalized maximum sequence energy ω̅_{t, b1, b2, . . . , b}_{ₜ₋₁} is based on the alphabet [symbol] and the shaping parameter v. For example,

$${\overline{ω}}_{t , b 1 , b 2 , … , {b}_{t - 1}} = {\overline{ω}}_{t , b 1 , b 2 , … {b}_{t - 1}}^{[ m ]} ( v ) .$$

The correspondence in value between the shaping parameter v and each respective normalized maximum sequence energy may be, for example, either a priori tabulated in one more look-up tables or computationally determined in real-time. The maximum sequence energy may then be computed as:

$${\overline{E}}_{t , b 1 , b 2 , … {b}_{t - 1}} = {n}_{t , b 1 , b 2 , … , {b}_{t - 1}} {\overline{ω}}_{t , b 1 , b 2 , … , {b}_{t - 1}} ( υ )$$

Each energy-based encoding operation (block 802) then determines a respective bit-level length k_{t, b1, b2, . . . , b}_{ₜ₋₁} based on the corresponding respective bit-level energy threshold Ē_{t, b1, b2, . . . , b}_{ₜ₋₁} such that

$${k}_{t , {b}_{1} , {b}_{2} , … , {b}_{t - 1}} \leq {log}_{2} {N}_{c}^{[ 2 ]} ( {n}_{t , b 1 , b 2 , … {b}_{t - 1}} , {\overline{E}}_{t , b 1 , b 2 , … , {b}_{t - 1}} ) .$$

Thus, the determination of k_{t, b1, b2, . . . , b}_{ₜ₋₁} is based on n_{t, b1, b2, . . . , b}_{ₜ₋₁} and Ē_{t, b1, b2, . . . , b}_{ₜ₋₁}. Each energy-based encoding operation (block 802) then obtain a respective set of information bits (e.g., u^{k}^{_{t,b1,b2, . . . , bt-1}} )having the respective bit-level length k_{t, b1, b2, . . . , b}_{ₜ₋₁}.

Each energy-based encoding operation (block 802) then encodes the respective set of information bits (u^{k}^{_{t,b1,b2, . . . , bt-1}}) to produce a respective shaped bit sequence bⁿ^{_{t,b1,b2, . . . , bt-1}}. The respective shaped bit sequence generated by the energy-based encoding operation with index {t, (b₁, b₂, . . . , bₜ₋₁)} has a respective bit-level length of n_{t, b1, b2, . . . , b}_{ₜ₋₁} and an energy (e.g., total number of bits having a binary value of one) less than or equal to Ē_{t, b1, b2, . . . , b}_{ₜ₋₁}. Each energy-based encoding operation further determines a respective first number of bits having a binary value of zero and a respective second number of bits having a binary value of one. For example, each energy-based encoding operation with index {t, (b₁, b₂, . . . , bₜ₋₁)} determines n_{t, b1, b2, . . . , b}_{ₜ₋₁}_{.1} and n_{t, b1, b2, . . . , b}_{ₜ₋₁}_{.0} based on bⁿ^{_{t,b1,b2, . . . , bt-1}}. It should be noted that there is a conservation of:

$${n}_{t , b 1 , b 2 , … , {b}_{t - 1} \cdot 1} + {n}_{t , b 1 , b 2 , … , {b}_{t - 1} \cdot 0} = {n}_{t , b 1 , b 2 , … , {b}_{t - 1}}$$

Then, t may be incremented by one until t=M−1.

The respective sets of one or more shaped bit sequences 806 output from each of the one or more bit-level energy-based encoding blocks 802 in each of the bit levels 808a, 808b, 808c, . . . , 808M−1 collectively form a plurality of amplitude bits that are input to the bit-to-symbol mapper 810. The bits-to-symbol mapper 810 performs a bit-to-symbol mapping operation on the shaped bit sequence, thereby generating a symbol sequence 812 (sⁿ). The symbol sequence 812 may have a symbol sequence length of n. The bit-to-symbol mapper 810 may perform the mapping based at least in part on the shaped bit sequences 806 and a bits-to-symbol labeling strategy. For example, the bits-to-symbol labeling strategy may include natural labeling, Gray labeling, or one-to-one labeling.

In an example, the bits-to-symbol mapper 810 may sequentially read off one bit from a respective shaped bit sequence 806 that corresponds to a respective bit level 808a, 808b, . . . , 808M−1. For example, the sequential reading off is performed from bit level 1 808a to bit level M−1 808M−1. For example, one bit may read from bⁿ^{₁} and denote it as b₁. For t ranges from 2 to M−1, one bit may be read from bⁿ^{_{t,b1,b2, . . . , bt-1}} and denote it as bₜ. Then, the bit-to-symbol mapper 810 may map (b₁, b₂, . . . , b_{M-1}) to a symbol in alphabet [symbol] according to the bits-to-symbol labeling strategy, thereby generating an element of sⁿ 812.

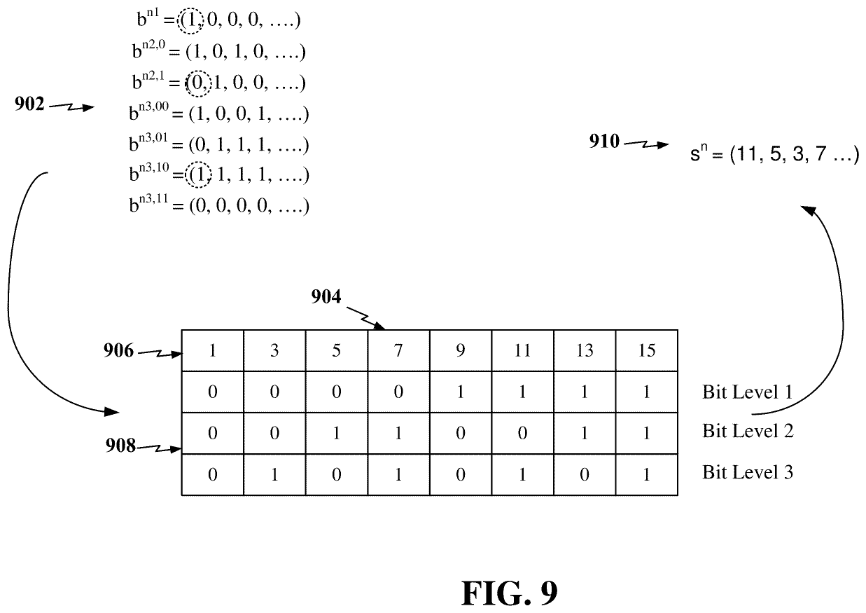

FIG. 9 is a diagram illustrating another example of a bits-to-symbol mapping operation according to some aspects. In the example shown in FIG. 9, a natural bits-to-symbol labeling strategy is used (e.g., for ASK-16 or QAM-256). In addition, three bit levels, each providing a set of one or more shaped bit sequences 902 (e.g., bⁿ^{₁} for the first bit level (bit level one), bⁿ^{_{2,0}}, bⁿ^{_{2,1}}) for the second bit level (bit level 2), and bⁿ^{_{3,00}}, bⁿ^{_{3,01}}, bⁿ^{_{3,10}}, bⁿ^{_{3,10}} for the third bit level (bit level 3)) are provided for illustration. However, depending on the alphabet size, more or fewer bit levels and corresponding shaped bit sequences may be generated. Here, bⁿ^{₁}=(1, 0, 0, 0, . . . ), bⁿ^{_{2,0}}=(1, 0, 1, 0, . . . ), bⁿ^{_{2,1}}=(0, 1, 0, 0, . . . ), bⁿ^{_{3,00}}=(1, 0, 0, 1, . . . ), bⁿ^{_{3,01}}=(0, 1, 1, 1, . . . ), bⁿ^{_{3,10}}=(1, 1, 1, 1, . . . ), and bⁿ^{_{3,11}}=(0, 0, 0, 0, . . . ).

In the natural labeling strategy, one bit in each bit level (e.g., from one of the one or more shaped bit sequences 902 in that bit level) is used as input to a table 904 containing symbols 906 and corresponding bit values 908 to generate the corresponding position symbol in an output symbol sequence 910 (sⁿ). For example, the first bit in the shaped bit sequence bⁿ^{₁} from the first bit level has a binary value of one. The next bit is then selected from the shaped bit sequence produced by the binary value bit-level energy-based encoding block in the second bit level associated with the binary value of one in the first bit level (e.g., the bit-level energy-based encoding block that took as input the number of binary value ones in the previous bit level). Thus, the next bit is selected from the shaped bit sequence bⁿ^{_{2,1}}. The first bit in this shaped bit sequence bⁿ^{_{2,1}} has a binary value of zero. As such, the next bit is selected from the shaped bit sequence produced by the binary value bit-level energy-based encoding block in the third bit level associated with the binary value of one in the first bit level and the binary value of zero in the second bit level. Thus, the next bit is selected from the shaped bit sequence bⁿ^{_{3,10}}. The first bit in this shaped bit sequence bⁿ^{_{3,1,0}} has a binary value of one. The resulting bit combination (e.g., 1, 0, 1) produces a first output symbol of 11. Similarly, taking the second bit in the shaped bit sequence bⁿ^{₁} from the first bit level and corresponding bits from one of the shaped bit sequences in each of the remaining bit levels as input to the table 904 produces a second output symbol of 5. By inputting the corresponding bits from each bit level to the table 904, the resulting output symbol sequence 910 may be sⁿ=(11, 5, 3, 7, . . . ).

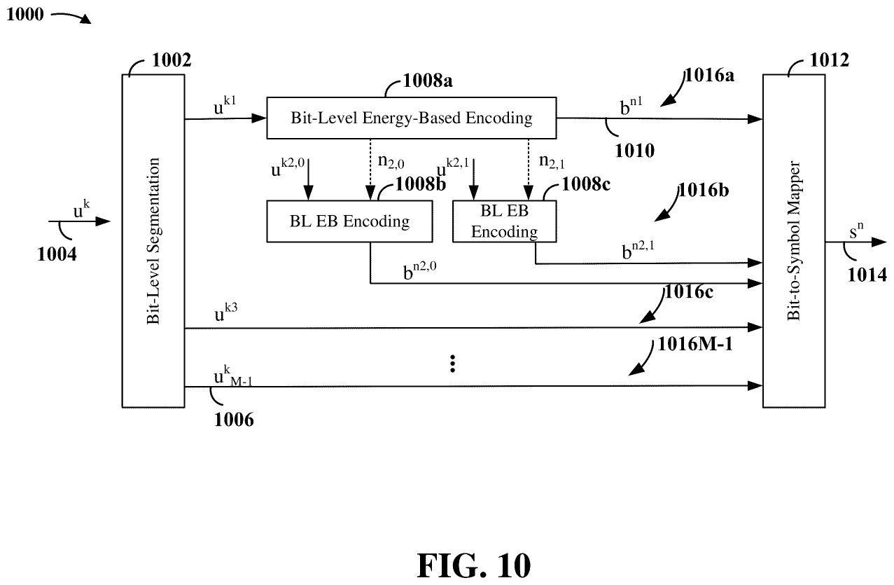

FIG. 10 is a diagram illustrating another example of bit-level energy shaping circuitry according to some aspects. The circuitry 1000 may be included, for example, in a PAS architecture of a transmitter chain of a wireless communication device (e.g., UE or network entity). The circuitry 1000 includes a bit-level segmentation block 1002, bit-level energy-based encoding block(s) 1008a, 1008b, and 1008c, and a bit-to-symbol mapper 1012. The bit-level segmentation block 1002 is configured to segment a plurality of information bits (u^{k}) 1004 into one or more segmented bit sequences 1006 (e.g., u^{k}^{₁}, u^{k}^{_{2,0}}, u^{k}^{_{2,1}}, u^{k}^{₃}, . . . , u^{k}^{_{M-1}}) for each bit level 1016a, 1016b, 1016c, . . . , 1016M−1. Each segmented bit sequence 1006 has a respective bit-level length.

From the bit-level lengths of each of the one or more segmented bit sequences, a bit sequence length of the plurality of information bits 1004 may be ascertained. Thus, the bit-level segmentation block 1002 may first determine the respective bit-level length of each of the segmented bit sequences 1006 for each of the bit levels 1016a, 1016b, . . . , 1016M−1 and then obtain a plurality of information bits 1004 equal to a sum of all of the bit-level lengths. The bit-level segmentation block 1002 may then segment the plurality of information bits 1004 into the one or more segmented bit sequences 1006 in accordance with the respective bit-level lengths of each of the segmented bit sequences 1006 in each of the bit-levels 1016a, 1016b, . . . , 1016M−1.

In the example shown in FIG. 10, energy-based encoding operations may be performed hierarchically across different bit levels 1016a, 1016b, 1016c, . . . 1016M−1 and in parallel for a same bit level. Thus, the bit-level lengths of each of the one or more segmented bit sequences 1006 may be dependent upon a previous bit level. As such, the bit-level segmentation block 1002 may obtain a respective set of information bits for each bit level sequentially based on the bit-level energy-based encoding operation(s) in the previous bit level. Segmentation in this example is artificial, as the segmentation is performed at the time the set of information bits are obtained for each bit level.

In addition, in the example shown in FIG. 10, an energy-based encoding operation may be performed for less than all of the bit levels 1016a, 1016b, 1016c, . . . 1016M−1. Thus, an energy-based encoding operation may be skipped for one or more of the bit levels. Here, the one or more skipped bitt levels may be less than logarithm of the alphabet size m under base 2. For each skipped bit level, the corresponding bit-level sequence length is equal to the sequence length n (e.g., kᵢ=n for all i∈{2, . . . , m}). For each non-skipped bit level, the corresponding bit-level sequence length may be determined based on a corresponding bit-level energy threshold and a symbol sequence length n (e.g., as determined from the previous bit level). The skipped bit levels may be regarded as a special form of shaped distribution corresponding to uniform distribution.

In the example shown in FIG. 10, the first two bit levels corresponding to the most-significant bit (MSB) bit levels 1016a and 1016b are energy encoded and the remaining (least-significant bit (LSB)) bit levels 1016c . . . 1016M−1 are skipped. For example, the segmented bit sequence u^{k}^{₁} may be input to the bit-level energy-based encoding block 1008a to perform a bit-level energy-based encoding operation on the segmented bit sequence to produce a shaped bit sequence bⁿ^{₁} 1010. In addition, bit-level energy-based encoding blocks 1008b and 1008c may receive as input from the bit-level energy-based encoding block 1008a of the first bit level 1016a, the number of binary value zero bits n_{2,0} or binary value one bits n_{2,1}. Energy-based encoding blocks 1008b and 1008c may then determine a respective energy threshold (Ē_{2,0} or Ē_{2,1}) based at least in part on the sequence length n_{2,0} or n_{2,1}, the alphabet [symbol] , and the shaping parameter v. Based on the respective energy thresholds and sequences lengths, the respective bit-level lengths for the segmented bit sequences u^{k}^{_{2,0}} and u^{k}^{_{2,1}} may be ascertained and the bit-level segmentation block 1002 may obtain the corresponding segmented bit sequences for input to the bit-level energy-based encoding blocks 1008b and 1008c. The bit-level energy-based encoding block 1008b and 1008c may then perform respective energy-based encoding operations on the sets of information bits (segmented bit sequences) u^{k}^{_{2,0}} and u^{k}^{_{2,1}} to produce respective shaped bit sequence bⁿ^{_{2,0}} and bⁿ^{_{2,1}}.

The shaped bit sequences 1010 and skipped segmented bit sequences 1006 (e.g., u^{k}^{₃}, . . . , u^{k}^{_{M-1}}) may collectively form the plurality of amplitude bits that may then be input to the bit-to-symbol mapper 1012, which performs a bit-to-symbol mapping operation using a bit-to-symbol labeling strategy to generate a symbol sequence 1014 (sⁿ). The symbol sequence 1014 may have a symbol sequence length of n. In an example, the bits-to-symbol mapper 1012 may perform a total number of n bits-to-symbol conversions. Each bits-to-symbol conversion may take as input M−1 bits, each one of which is from a respective shaped bit sequence 1010 or skipped segmented bit sequence 1006 of a respective bit level 1016a, 1016b, . . . , 1016M−1 and map the M−1 bits to a symbol of the alphabet [symbol] , thereby generating an element of sⁿ 1014.

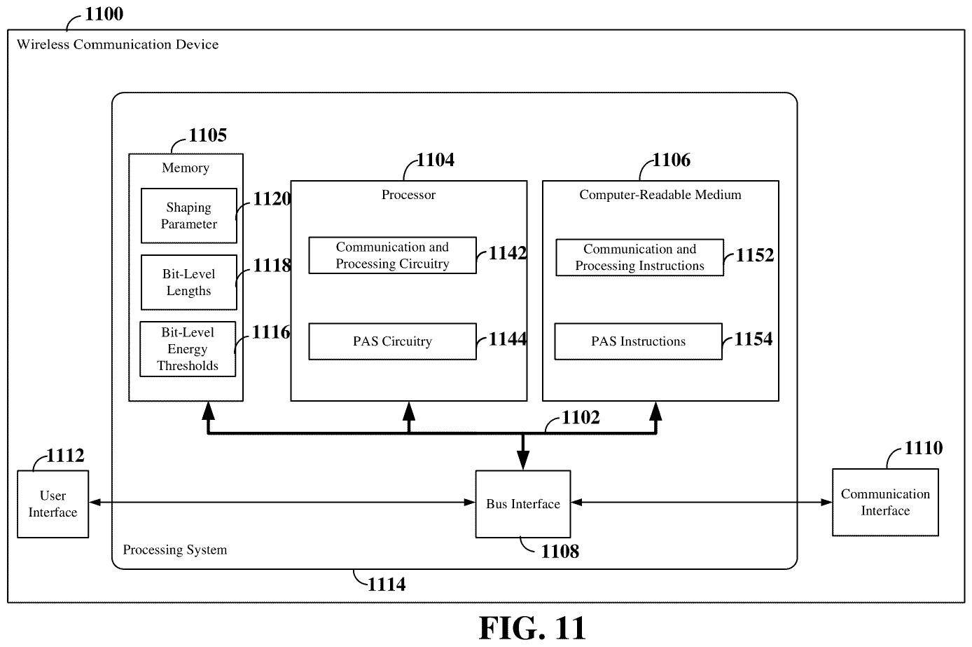

FIG. 11 is a block diagram illustrating an example of a hardware implementation of a wireless communication device 1100 employing a processing system 1114 according to some aspects. For example, the wireless communication device 1100 may correspond to any of the UEs or network entities shown and described above in reference to FIGS. 1 and/or 2. In some examples, a network entity may be, for example, any base station (e.g., gNB, eNB) or other scheduling entity as illustrated in any one or more of FIGS. 1 and/or 2. A network entity may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, a network entity may be a stationary network entity or a mobile network entity.

In accordance with various aspects of the disclosure, an element, or any portion of an element, or any combination of elements may be implemented with a processing system 1114 that includes one or more processors, such as processor 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1100 may be configured to perform any one or more of the functions described herein. That is, the processor 1104, as utilized in the wireless communication device 1100, may be used to implement any one or more of the methods or processes described and illustrated, for example, in FIGS. 3-10 and/or 12.

The processor 1104 may in some instances be implemented via a baseband or modem chip and in other implementations, the processor 1104 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits, including one or more processors (represented generally by the processor 1104), one or more memories (represented generally by the memory 1105), and one or more computer-readable media (represented generally by the computer-readable medium 1106). In some examples, the computer-readable media 1106 may be included within or part of one or more of the memories 1105. The bus 1102 may also link various other circuits such as timing sources, peripherals, voltage regulators, and power management circuits, which are well known in the art, and therefore, are not described any further.

A bus interface 1108 provides an interface between the bus 1102 and one or more communication interfaces 1110. In some examples, the communication interface 1110 may include one or more transceivers (e.g., one or more wireless transceivers) and one or more antenna arrays (e.g., one or more antenna panels). The communication interface 1110 provides a means for communicating with various other apparatus over a transmission medium (e.g., air interface). The bus interface 1108 further provides an interface between the bus 1102 and a user interface 1112 (e.g., keypad, display, touch screen, speaker, microphone, control features, etc.). Of course, such a user interface 1112 may be omitted in some examples.

The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. By way of example, a computer program product may include a computer-readable medium in packaging materials. In some examples, the computer-readable medium 1106 may be part of the memory 1105. Those skilled in the art will recognize how best to implement the described functionality presented throughout this disclosure depending on the particular application and the overall design constraints imposed on the overall system. In some examples, the computer-readable medium 1106 may be implemented on an article of manufacture, which may further include one or more other elements or circuits, such as the processor 1104 and/or memory 1105.

The computer-readable medium 1106 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1104, may be responsible for managing the bus 1102 and general processing, including the execution of the software (e.g., instructions or computer-executable code) stored on the computer-readable medium 1106. The software, when executed by the processor 1104, causes the processing system 1114 to perform the various processes and functions described herein for any particular apparatus. The computer-readable medium 1106 and/or the memory 1105 may also be used for storing data that may be manipulated by the processor 1104 when executing software. For example, the memory 1105 may store one or more bit-level energy thresholds 1116, one or more bit-level lengths 1118, and a shaping parameter 1120.

In some aspects of the disclosure, the processor 1104 may include circuitry configured for various functions. For example, the processor 1104 may include communication and processing circuitry 1142 configured to communicate with one or more UEs and/or one or more network entities. In some examples, the communication and processing circuitry 1142 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1142 may include one or more transmit/receive chains. The communication and processing circuitry 1142 may further be configured to execute communication and processing software 1152 stored on the computer-readable medium 1106 to implement one or more functions described herein.

The processor 1104 may further include probabilistic amplitude shaping (PAS) circuitry 1144, configured to perform bit-level energy-based shaping. The PAS circuitry 1144 may correspond, for example, to the PAS architecture shown in FIGS. 3 and/or 6 and may include the energy-based shaping circuitry shown in FIGS. 4, 7, 8, and/or 10.

In some examples, the PAS circuitry 1144 may be configured to obtain a plurality of information bits, perform an energy-based encoding operation on the plurality of information bits to produce a plurality of amplitude bits and to map the plurality of amplitude bits to a plurality of symbols to generate a symbol sequence having a non-uniform distribution over constellation points of an alphabet of symbols forming the symbol sequence. In some examples, the PAS circuitry 1144 may further be configured to segment the plurality of information bits into one or more segmented bit sequences. Each of the one or more segmented bit sequences may correspond to a bit level, and each of the one or more segmented bit sequences may include a respective bit-level length 1118. The PAS circuitry 1144 may further be configured to perform the energy-based encoding operation on at least one of the one or more segmented bit sequences in parallel to produce respective shaped bit sequences forming the plurality of amplitude bits. Each of the respective shaped bit sequences may correspond to a respective non-uniform distribution over a set of binary bit values {0, 1} (e.g., a respective target distribution over {0, 1}, such that when the shaped bit sequences are converted to a symbol sequence of amplitude symbols, the empirical distribution over the amplitude symbols is approximately equal to a target non-uniform distribution over constellation points of the alphabet of symbols).

The PAS circuitry 1144 may further be configured to determine the respective bit-level length of each of the one or more segmented bit sequences based on a corresponding bit-level energy threshold 1116 of one or more bit-level energy thresholds 1116 and determine a bit sequence length of the plurality of information bits as a sum of the respective bit-level lengths 1118 of each of the one or more segmented bit sequences. In some examples, the PAS circuitry 1144 may be configured to determine a first number of the one or more bit-level energy thresholds 1116 corresponding to a second number of the one or more segmented bit sequences based on an alphabet size of the alphabet of symbols. The PAS circuitry 1144 may further be configured to determine the corresponding bit-level energy threshold 1116 for each of the one or more segmented bit sequences based on a symbol sequence length of the symbol sequence and a shaping parameter 1120. In some examples, the shaping parameter 1120 may be associated with a Maxwell Boltzmann distribution over the alphabet of symbols.

In some examples, the PAS circuitry 1144 may be configured to determine the corresponding bit-level energy threshold 1116 for each of the one or more segmented bit sequences based on a product of the symbol sequence length and a respective normalized maximum sequence energy, the respective normalized maximum sequence energy being based on the shaping parameter 1120. In some examples, each of the shaped bit sequences may include a shaped bit length equal to the symbol sequence length and a respective number of bits having a binary value of one at most equal to the corresponding bit-level energy threshold. In some examples, the energy-based encoding operation includes at least one of an energy-based arithmetic coding operation or an energy-based peeling operation.

The PAS circuitry 1144 may further be configured to map the respective shaped bit sequences to the plurality of symbols using a bits-to-symbol labeling strategy. In some examples, the PAS circuitry 1144 may further be configured to apply systematic forward error correction (FEC) to the respective shaped bit sequences and additional information bits to generate a plurality of parity bits, convert the plurality of parity bits and the additional information bits to a sequence of sign bits, and to pointwise multiply the sequence of sign bits with the symbol sequence to generate a transmission symbol sequence for transmission by the wireless communication device.

In some examples, the PAS circuitry 1144 may be configured to perform the energy-based encoding operation on each of the one or more segmented bit sequences in parallel. In some examples, the PAS circuitry 1144 may be configured to perform the energy-based encoding operation on a first set of the one or more segmented bit sequences and to skip the energy-based encoding operation on a second set of the one or more segmented bit sequences. In this example, the respective bit-level length 1118 of the second set of the one or more segmented bit sequences is equal to a symbol sequence length of the symbol sequence.

The PAS circuitry 1144 may further be configured to determine a first bit-level length 1118 of a first bit level of a plurality of bit levels based on a corresponding first bit-level energy threshold 1116 of one or more bit-level energy thresholds, obtain a first set of information bits of the plurality of information bits corresponding to the bit-level length 1118 and to perform the energy-based encoding operation on the first set of information bits to produce a first shaped bit sequence.

The PAS circuitry 1144 may further be configured to, for at least one bit level of the plurality of bit levels after the first bit level, perform a plurality of energy-based encoding operations. For each of the plurality of energy-based encoding operations of a bit level, the PAS circuitry 1144 may be configured to determine a respective binary value sequence length from a previous bit level of the plurality of bit levels. The respective binary value sequence length may include a first number of bits having a binary value of zero or a second number of bits having a binary value of one from a previous shaped bit sequence of the previous bit level. For each of the plurality of energy-based encoding operations of a bit level, the PAS circuitry 1144 may further be configured to determine a respective bit-level length 1118 based on a corresponding respective bit-level energy threshold 1116 of the one or more bit-level energy thresholds and the respective binary value sequence length, obtain a respective set of information bits of the plurality of information bits corresponding to the respective bit-level length, and perform the respective energy-based encoding operation on the respective set of information bits to produce a respective shaped bit sequence. The respective shaped bit sequences from each of the plurality of bit levels including the first bit level forming the plurality of amplitude bits. Each of the respective shaped bit sequences having a respective non-uniform distribution over a set of binary bit values {0, 1} (e.g., a respective target distribution over {0, 1}, such that when the shaped bit sequences are converted to a symbol sequence of amplitude symbols, the empirical distribution over the amplitude symbols is approximately equal to a target non-uniform distribution over constellation points of the alphabet of symbols). The PAS circuitry 1144 may further be configured to perform the respective energy-based encoding operations on a same bit level of the plurality of bit levels in parallel.

The PAS circuitry 1144 may further be configured to determine a bit sequence length of the plurality of information bits as a sum of the respective bit-level lengths 1118. The PAS circuitry 1144 may further be configured to determine the corresponding bit-level energy threshold 1116 for each of the energy-based encoding operations based on the output sequence length from the previous bit level and the shaping parameter 1120. In this example, the shaping parameter 1120 may be associated with a Maxwell Boltzmann distribution over the alphabet of symbols.

The PAS circuitry 1144 may further be configured to determine the corresponding bit-level energy threshold 1116 for each of the energy-based encoding operations based on a product of the output sequence length from the previous bit level and a respective normalized maximum sequence energy, in which the respective normalized maximum sequence energy being based on the shaping parameter 1120. In some examples, each of the respective shaped bit sequences may include a respective number of bits having a binary value of one at most equal to the corresponding bit-level energy threshold 1116. In some examples, the energy-based encoding operation includes at least one of an energy-based arithmetic coding operation or an energy-based peeling operation.

The PAS circuitry 1144 may further be configured to map the respective shaped bit sequences to the plurality of symbols using a bits-to-symbol labeling strategy in a hierarchical manner. The PAS circuitry 1144 may further be configured to skip the energy-based encoding operation on at least a second set of information bits of the plurality of information bits corresponding to a second bit level of the plurality of bit levels. The second bit-level length 1118 of the second set of information bits being equal to a symbol sequence length of the symbol sequence. The PAS circuitry 1144 may further be configured to execute PAS instructions (software) 1154 stored on the computer-readable medium 1106 to implement one or more functions described herein.

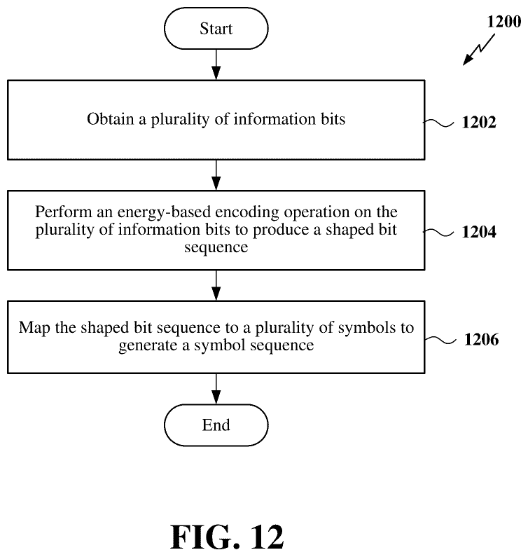

FIG. 12 is a flow chart illustrating an exemplary process 1200 for bit-level energy-based probabilistic amplitude shaping according to some aspects. As described below, some or all illustrated features may be omitted in a particular implementation within the scope of the present disclosure, and some illustrated features may not be required for implementation of all embodiments. In some examples, the process 1200 may be carried out by the wireless communication device 1100 illustrated in FIG. 11. In some examples, the process 1200 may be carried out by any suitable apparatus or means for carrying out the functions or algorithm described below.

At block 1202, the wireless communication device may obtain a plurality of information bits. For example, the PAS circuitry 1144 shown and described above in connection with FIG. 11 may provide a means to obtain the plurality of information bits.

At block 1204, the wireless communication device may perform an energy-based encoding operation on the plurality of information bits to produce a plurality of amplitude bits. For example, the PAS circuitry 1144 shown and described above in connection with FIG. 11 may provide a means to perform the energy-based encoding operation.

In some examples, the wireless communication device may segment the plurality of information bits into one or more segmented bit sequences. Each of the one or more segmented bit sequences may correspond to a bit level and each of the one or more segmented bit sequences may include a respective bit-level length. The wireless communication device may then perform the energy-based encoding operation on at least one of the one or more segmented bit sequences in parallel to produce respective shaped bit sequences forming the shaped bit sequence. Each of the respective shaped bit sequences may correspond to a respective non-uniform distribution over a set of binary bit values.

The wireless communication device may further be configured to determine the respective bit-level length of each of the one or more segmented bit sequences based on a corresponding bit-level energy threshold of one or more bit-level energy thresholds and determine a bit sequence length of the plurality of information bits as a sum of the respective bit-level lengths of each of the one or more segmented bit sequences. In some examples, the wireless communication device may be configured to determine a first number of the one or more bit-level energy thresholds corresponding to a second number of the one or more segmented bit sequences based on an alphabet size of the alphabet of symbols. The wireless communication device may further be configured to determine the corresponding bit-level energy threshold for each of the one or more segmented bit sequences based on a symbol sequence length of the symbol sequence and a shaping parameter. In some examples, the shaping parameter may be associated with a Maxwell Boltzmann distribution over the alphabet of symbols.

In some examples, the wireless communication device may be configured to determine the corresponding bit-level energy threshold for each of the one or more segmented bit sequences based on a product of the symbol sequence length and a respective normalized maximum sequence energy, the respective normalized maximum sequence energy being based on the shaping parameter. In some examples, each of the shaped bit sequences may include a shaped bit length equal to the symbol sequence length and a respective number of bits having a binary value of one at most equal to the corresponding bit-level energy threshold. In some examples, the energy-based encoding operation includes at least one of an energy-based arithmetic coding operation or an energy-based peeling operation.

In some examples, the wireless communication device may be configured to perform the energy-based encoding operation on each of the one or more segmented bit sequences in parallel. In some examples, the wireless communication device may be configured to perform the energy-based encoding operation on a first set of the one or more segmented bit sequences and to skip the energy-based encoding operation on a second set of the one or more segmented bit sequences. In this example, the respective bit-level length of the second set of the one or more segmented bit sequences is equal to a symbol sequence length of the symbol sequence.

The wireless communication device may further be configured to determine a first bit-level length of a first bit level of a plurality of bit levels based on a corresponding first bit-level energy threshold of one or more bit-level energy thresholds, obtain a first set of information bits of the plurality of information bits corresponding to the bit-level length and to perform the energy-based encoding operation on the first set of information bits to produce a first shaped bit sequence.

The wireless communication device may further be configured to, for each bit level of the plurality of bit levels after the first bit level, perform a plurality of energy-based encoding operations. For each of the plurality of energy-based encoding operations of a bit level, the wireless communication device may be configured to determine a respective binary value sequence length from a previous bit level of the plurality of bit levels. The respective binary value sequence length may include a first number of bits having a binary value of zero or a second number of bits having a binary value of one from a previous shaped bit sequence of the previous bit level. For each of the plurality of energy-based encoding operations of a bit level, the wireless communication device may further be configured to determine a respective bit-level length based on a corresponding respective bit-level energy threshold of the one or more bit-level energy thresholds and the respective binary value sequence length, obtain a respective set of information bits of the plurality of information bits corresponding to the respective bit-level length, and perform the respective energy-based encoding operation on the respective set of information bits to produce a respective shaped bit sequence. The respective shaped bit sequences from each of the plurality of bit levels including the first bit level forming the shaped bit sequence. Each of the respective shaped bit sequences having a respective non-uniform distribution over constellation points of an alphabet of symbols used to generate the symbol sequence. The wireless communication device may further be configured to perform the respective energy-based encoding operations on a same bit level of the plurality of bit levels in parallel.

The wireless communication device may further be configured to determine a bit sequence length of the plurality of information bits as a sum of the respective bit-level lengths. The wireless communication device may further be configured to determine the corresponding bit-level energy threshold for each of the energy-based encoding operations based on the output sequence length from the previous bit level and the shaping parameter. In this example, the shaping parameter may be associated with a Maxwell Boltzmann distribution over the alphabet of symbols.

The wireless communication device may further be configured to determine the corresponding bit-level energy threshold for each of the energy-based encoding operations based on a product of the output sequence length from the previous bit level and a respective normalized maximum sequence energy, in which the respective normalized maximum sequence energy being based on the shaping parameter. In some examples, each of the respective shaped bit sequences may include a respective number of bits having a binary value of one at most equal to the corresponding bit-level energy threshold. In some examples, the energy-based encoding operation includes at least one of an energy-based arithmetic coding operation or an energy-based peeling operation. The wireless communication device may further be configured to skip the energy-based encoding operation on at least a second set of information bits of the plurality of information bits corresponding to a second bit level of the plurality of bit levels. The second bit-level length of the second set of information bits being equal to a symbol sequence length of the symbol sequence.

At block 1206, the wireless communication device may map the shaped bit sequence to a plurality of symbols to generate a symbol sequence having a non-uniform distribution over constellation points of an alphabet of symbols forming the symbol sequence. For example, the PAS circuitry 1144 shown and described above in connection with FIG. 11 may provide a means to map the shaped bit sequence to the plurality of symbols.

In some examples, the wireless communication device may further be configured to map the respective shaped bit sequences to the plurality of symbols using a bits-to-symbol labeling strategy. In some examples, the wireless communication device may further be configured to apply systematic forward error correction (FEC) to the respective shaped bit sequences and additional information bits to generate a plurality of parity bits, convert the plurality of parity bits and the additional information bits to a sequence of sign bits, and to pointwise multiply the sequence of sign bits with the symbol sequence to generate a transmission symbol sequence for transmission by the wireless communication device. In some examples, the wireless communication device may further be configured to map the respective shaped bit sequences to the plurality of symbols using a bits-to-symbol labeling strategy in a hierarchical manner.

In one configuration, the wireless communication device includes means for obtaining a plurality of information bits, means for performing an energy-based encoding operation on the plurality of information bits to produce a shaped bit sequence, and means for mapping the shaped bit sequence to a plurality of symbols to generate a symbol sequence having a non-uniform distribution over constellation points of an alphabet of symbols forming the symbol sequence. In one aspect, the aforementioned means may be the processor 1104 shown in FIG. 11 configured to perform the functions recited by the aforementioned means. In another aspect, the aforementioned means may be a circuit or any apparatus configured to perform the functions recited by the aforementioned means.

Of course, in the above examples, the circuitry included in the processor 1104 is merely provided as an example, and other means for carrying out the described functions may be included within various aspects of the present disclosure, including but not limited to the instructions stored in the computer-readable storage medium 1106, or any other suitable apparatus or means described in any one of the FIGS. 1-4, 6-8, 10, and/or 11, and utilizing, for example, the processes and/or algorithms described herein in relation to FIG. 12.

The following provides an overview of aspects of the present disclosure:

Aspect 1: A method operable at a wireless communication device, the method comprising: obtaining a plurality of information bits; performing an energy-based encoding operation on the plurality of information bits to produce a plurality of amplitude bits; and mapping the plurality of amplitude bits to a plurality of symbols to generate a symbol sequence having a non-uniform distribution over constellation points of an alphabet of symbols forming the symbol sequence.

Aspect 2: The method of aspect 1, wherein the performing the energy-based encoding operation further comprises: segmenting the plurality of information bits into one or more segmented bit sequences, each of the one or more segmented bit sequences corresponding to a bit level, each of the one or more segmented bit sequences comprising a respective bit-level length; and performing the energy-based encoding operation on at least one of the one or more segmented bit sequences in parallel to produce respective shaped bit sequences forming the plurality of amplitude bits, each of the respective shaped bit sequences having a respective non-uniform distribution over a set of binary bit values.

Aspect 3: The method of aspect 2, further comprising: determining the respective bit-level length of each of the one or more segmented bit sequences based on a corresponding bit-level energy threshold of one or more bit-level energy thresholds; and determining a bit sequence length of the plurality of information bits as a sum of the respective bit-level lengths of each of the one or more segmented bit sequences.

Aspect 4: The method of aspect 3, further comprising: determining a first number of the one or more bit-level energy thresholds corresponding to a second number of the one or more segmented bit sequences based on an alphabet size of the alphabet of symbols; and determining the corresponding bit-level energy threshold for each of the one or more segmented bit sequences based on a symbol sequence length of the symbol sequence and a shaping parameter.

Aspect 5: The method of aspect 4, wherein the shaping parameter is associated with a Maxwell Boltzmann distribution over the alphabet of symbols.

Aspect 6: The method of aspect 4 or 5, wherein the determining the corresponding bit-level energy threshold for each of the one or more segmented bit sequences further comprises: determining the corresponding bit-level energy threshold for each of the one or more segmented bit sequences based on a product of the symbol sequence length and a respective normalized maximum sequence energy, the respective normalized maximum sequence energy being based on the shaping parameter.

Aspect 7: The method of aspect 6, wherein each of the shaped bit sequences comprises a shaped bit length equal to the symbol sequence length and a respective number of bits having a binary value of one at most equal to the corresponding bit-level energy threshold.

Aspect 8: The method of any of aspects 2 through 7, wherein the energy-based encoding operation comprises at least one of an energy-based arithmetic coding operation or an energy-based peeling operation.

Aspect 9: The method of any of aspects 2 through 8, wherein the mapping the plurality of amplitude bits further comprises: mapping the respective shaped bit sequences to the plurality of symbols using a bits-to-symbol labeling strategy.

Aspect 10: The method of any of aspects 2 through 9, further comprising applying systematic forward error correction to the respective shaped bit sequences and additional information bits to generate a plurality of parity bits; converting the plurality of parity bits and the additional information bits to a sequence of sign bits; and pointwise multiplying the sequence of sign bits with the symbol sequence to generate a transmission symbol sequence for transmission by the wireless communication device.

Aspect 11: The method of any of aspects 2 through 10, wherein the performing the energy-based encoding operation on at least one of the one or more segmented bit sequences in parallel further comprises: performing the energy-based encoding operation on each of the one or more segmented bit sequences in parallel.

Aspect 12: The method of any of aspects 2 through 10, wherein the performing the energy-based encoding operation on at least one of the one or more segmented bit sequences in parallel further comprises: performing the energy-based encoding operation on a first set of the one or more segmented bit sequences; and skipping the energy-based encoding operation on a second set of the one more segmented bit sequences, wherein the respective bit-level length of the second set of the one or more segmented bit sequences is equal to a symbol sequence length of the symbol sequence.

Aspect 13: The method of aspect 1, wherein the obtaining the plurality of information bits further comprises: determining a first bit-level length of a first bit level of a plurality of bit levels based on a corresponding first bit-level energy threshold of one or more bit-level energy thresholds; and obtaining a first set of information bits of the plurality of information bits corresponding to the bit-level length, wherein the performing the energy-based encoding operation further comprises: performing the energy-based encoding operation on the first set of information bits to produce a first shaped bit sequence.

Aspect 14: The method of aspect 13, wherein the performing the energy-based encoding operation further comprises: for at least one bit level of the plurality of bit levels after the first bit level, performing a plurality of energy-based encoding operations, and for each of the plurality of energy-based encoding operations: determining a respective binary value sequence length from a previous bit level of the plurality of bit levels, the respective binary value sequence length comprising a first number of bits having a binary value of zero or a second number of bits having a binary value of one from a previous shaped bit sequence of the previous bit level; determining a respective bit-level length based on a corresponding respective bit-level energy threshold of the one or more bit-level energy thresholds and the respective binary value sequence length; obtaining a respective set of information bits of the plurality of information bits corresponding to the respective bit-level length; and performing the respective energy-based encoding operation on the respective set of information bits to produce a respective shaped bit sequence, the respective shaped bit sequences from each of the plurality of bit levels including the first bit level forming the plurality of amplitude bits, each of the respective shaped bit sequences having a respective non-uniform distribution over a set of binary bit values.

Aspect 15: The method of aspect 14, wherein performing the energy-based encoding operation further comprises: performing the respective energy-based encoding operations on a same bit level of the plurality of bit levels in parallel.

Aspect 16: The method of aspect 14 or 15, further comprising: determining a bit sequence length of the plurality of information bits as a sum of the respective bit-level lengths.

Aspect 17: The method of aspect 16, further comprising: determining the corresponding bit-level energy threshold for each of the energy-based encoding operations based on the output sequence length from the previous bit level and a shaping parameter.

Aspect 18: The method of aspect 17, wherein the shaping parameter is associated with a Maxwell Boltzmann distribution over the alphabet of symbols.

Aspect 19: The method of aspect 17 or 18, wherein the determining the corresponding bit-level energy threshold for each of the energy-based encoding operations further comprises: determining the corresponding bit-level energy threshold for each of the energy-based encoding operations based on a product of the output sequence length from the previous bit level and a respective normalized maximum sequence energy, the respective normalized maximum sequence energy being based on the shaping parameter.

Aspect 20: The method of any of aspects 14 through 19, wherein each of the respective shaped bit sequences comprises a respective number of bits having a binary value of one at most equal to the corresponding bit-level energy threshold.

Aspect 21: The method of any of aspects 14 through 20, wherein the energy-based encoding operation comprises at least one of an energy-based arithmetic coding operation or an energy-based peeling operation.

Aspect 22: The method of any of aspects 14 through 21, wherein the mapping the plurality of amplitude bits further comprises: mapping the respective shaped bit sequences to the plurality of symbols using a bits-to-symbol labeling strategy in a hierarchical manner.

Aspect 23: The method of any of aspects 14 through 22, further comprising: skipping the energy-based encoding operation on at least a second set of information bits of the plurality of information bits corresponding to a second bit level of the plurality of bit levels, wherein a second bit-level length of the second set of information bits is equal to a symbol sequence length of the symbol sequence.

Aspect 24: An apparatus for wireless communication at a wireless communication device comprising one or more memories and one or more processors coupled to the one or more memories, the one or more processors being configured to perform a method of any of aspects 1 through 23.

Aspect 25: An apparatus configured for wireless communication comprising means for performing a method of any of aspects 1 through 23.

Aspect 26: A non-transitory computer-readable medium having stored therein instructions executable by one or more processors of an apparatus for wireless communication to perform a method of any one of aspects 1 through 23.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 4, 6-8, 10, and/or 11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. An apparatus for wireless communication at a wireless communication device, the apparatus comprising:
one or more memories; and
one or more processors coupled to the one or more memories, the one or more processors being configured to:
obtain a plurality of information bits;
perform an energy-based encoding operation on the plurality of information bits to produce a plurality of amplitude bits; and
map the plurality of amplitude bits to a plurality of symbols to generate a symbol sequence having a non-uniform distribution over constellation points of an alphabet of symbols forming the symbol sequence.

2. The apparatus of claim 1, wherein the one or more processors are further configured to:
segment the plurality of information bits into one or more segmented bit sequences, each of the one or more segmented bit sequences corresponding to a bit level, each of the one or more segmented bit sequences comprising a respective bit-level length; and
perform the energy-based encoding operation on at least one of the one or more segmented bit sequences in parallel to produce respective shaped bit sequences forming the plurality of amplitude bits, each of the respective shaped bit sequences having a respective non-uniform distribution over a set of binary bit values.

3. The apparatus of claim 2, wherein the one or more processors are further configured to:
determine the respective bit-level length of each of the one or more segmented bit sequences based on a corresponding bit-level energy threshold of one or more bit-level energy thresholds; and
determine a bit sequence length of the plurality of information bits as a sum of the respective bit-level lengths of each of the one or more segmented bit sequences.

4. (canceled)

5. (canceled)

6. (canceled)

7. (canceled)

8. The apparatus of claim 2, wherein the energy-based encoding operation comprises at least one of an energy-based arithmetic coding operation or an energy-based peeling operation.

9. The apparatus of claim 2, wherein the one or more processors are further configured to:
map the respective shaped bit sequences to the plurality of symbols using a bits-to-symbol labeling strategy.

10. The apparatus of claim 2, wherein the one or more processors are further configured to:
apply systematic forward error correction to the respective shaped bit sequences and additional information bits to generate a plurality of parity bits;
convert the plurality of parity bits and the additional information bits to a sequence of sign bits; and
pointwise multiply the sequence of sign bits with the symbol sequence to generate a transmission symbol sequence for transmission by the wireless communication device.

11. The apparatus of claim 2, wherein the one or more processors are further configured to:
perform the energy-based encoding operation on each of the one or more segmented bit sequences in parallel.

12. The apparatus of claim 2, wherein the one or more processors are further configured to:
perform the energy-based encoding operation on a first set of the one or more segmented bit sequences; and
skip the energy-based encoding operation on a second set of the one more segmented bit sequences, wherein the respective bit-level length of the second set of the one or more segmented bit sequences is equal to a symbol sequence length of the symbol sequence.

13. The apparatus of claim 1, wherein the one or more processors are further configured to:
determine a first bit-level length of a first bit level of a plurality of bit levels based on a corresponding first bit-level energy threshold of one or more bit-level energy thresholds; and
obtain a first set of information bits of the plurality of information bits corresponding to the bit-level length, wherein the performing the energy-based encoding operation further comprises:
perform the energy-based encoding operation on the first set of information bits to produce a first shaped bit sequence.

14. (canceled)

15. (canceled)

16. (canceled)

17. (canceled)

18. (canceled)

19. (canceled)

20. (canceled)

21. (canceled)

22. (canceled)

23. (canceled)

24. A method operable at a wireless communication device, the method comprising:
obtaining a plurality of information bits;
performing an energy-based encoding operation on the plurality of information bits to produce a plurality of amplitude bits; and
mapping the plurality of amplitude bits to a plurality of symbols to generate a symbol sequence having a non-uniform distribution over constellation points of an alphabet of symbols forming the symbol sequence.

25. The method of claim 24, wherein the performing the energy-based encoding operation further comprises:
segmenting the plurality of information bits into one or more segmented bit sequences, each of the one or more segmented bit sequences corresponding to a bit level, each of the one or more segmented bit sequences comprising a respective bit-level length; and
performing the energy-based encoding operation on at least one of the one or more segmented bit sequences in parallel to produce respective shaped bit sequences forming the plurality of amplitude bits, each of the respective shaped bit sequences having a respective non-uniform distribution over a set of binary bit values.

26. (canceled)

27. (canceled)

28. (canceled)

29. (canceled)

30. (canceled)

31. The method of claim 25, further comprising:
determining the respective bit-level length of each of the one or more segmented bit sequences based on a corresponding bit-level energy threshold of one or more bit-level energy thresholds; and
determining a bit sequence length of the plurality of information bits as a sum of the respective bit-level lengths of each of the one or more segmented bit sequences.

32. The method of claim 25, wherein the energy-based encoding operation comprises at least one of an energy-based arithmetic coding operation or an energy-based peeling operation.

33. The method of claim 25, further comprising:
mapping the respective shaped bit sequences to the plurality of symbols using a bits-to-symbol labeling strategy.

34. The method of claim 25, further comprising:
applying systematic forward error correction to the respective shaped bit sequences and additional information bits to generate a plurality of parity bits;
converting the plurality of parity bits and the additional information bits to a sequence of sign bits; and
pointwise multiplying the sequence of sign bits with the symbol sequence to generate a transmission symbol sequence for transmission by the wireless communication device.

35. The method of claim 25, further comprising:
performing the energy-based encoding operation on each of the one or more segmented bit sequences in parallel.

36. The method of claim 25, further comprising:
performing the energy-based encoding operation on a first set of the one or more segmented bit sequences; and
skipping the energy-based encoding operation on a second set of the one more segmented bit sequences, wherein the respective bit-level length of the second set of the one or more segmented bit sequences is equal to a symbol sequence length of the symbol sequence.

37. The method of claim 24, further comprising:
determining a first bit-level length of a first bit level of a plurality of bit levels based on a corresponding first bit-level energy threshold of one or more bit-level energy thresholds; and
obtaining a first set of information bits of the plurality of information bits corresponding to the bit-level length, wherein the performing the energy-based encoding operation further comprises:
performing the energy-based encoding operation on the first set of information bits to produce a first shaped bit sequence.

38. A non-transitory computer-readable medium having stored therein instructions executable by one or more processors of an apparatus for wireless communication to perform a method, comprising:
obtaining a plurality of information bits;
performing an energy-based encoding operation on the plurality of information bits to produce a plurality of amplitude bits; and
mapping the plurality of amplitude bits to a plurality of symbols to generate a symbol sequence having a non-uniform distribution over constellation points of an alphabet of symbols forming the symbol sequence.

39. The non-transitory computer-readable medium of claim 38, wherein the performing the energy-based encoding operation further comprises:
segmenting the plurality of information bits into one or more segmented bit sequences, each of the one or more segmented bit sequences corresponding to a bit level, each of the one or more segmented bit sequences comprising a respective bit-level length; and
performing the energy-based encoding operation on at least one of the one or more segmented bit sequences in parallel to produce respective shaped bit sequences forming the plurality of amplitude bits, each of the respective shaped bit sequences having a respective non-uniform distribution over a set of binary bit values.
